(19) United States
(12) Patent Application Publication
(10) Pub. No.: US 2010/0274883 A1
(43) Pub. Date: Oct. 28, 2010

(54) CONFIGURATION MANAGEMENT METHOD FOR COMPUTER SYSTEM INCLUDING STORAGE SYSTEMS

(76) Inventors: Masayuki YAMAMOTO, Sagamihara (JP); Daisuke Shinohara, Yokohama (JP); Takayuki Nagai, Machida (JP); Yasunori Kaneda, Sagamihara (JP)

Correspondence Address: BRUNDIDGE & STANGER, P.C., 2318 MILL ROAD, SUITE 1020, ALEXANDRIA, VA, 22314, US

(21) Appl. No.: 12/831,292

(22) Filed: Jul. 7, 2010

Related U.S. Application Data
(63) Continuation of application No. 11/176,301, filed on Jul. 8, 2005, now abandoned.

(30) Foreign Application Priority Data
Jun. 8, 2005 (JP) 2005-167675

(51) Int. Cl. G06F 15/173

(52) U.S. Cl. 709/223

(57) ABSTRACT

Responsive to a manipulation a storage administrator performs, the authority to manage the physical configuration of a storage system is either given or not given to the storage administrator. Specifically, a volume allocation program installed in a management computer gives the storage administrator the authority to manage the physical configuration of a storage system including a created volume, responsive to creation of a volume. A volume un-allocation program installed in the management computer verifies responsive to un-allocation of a volume whether the storage administrator is not given the authority to manage the physical configuration of the storage system including the un-allocated volume. Thus, by use of the two programs, the storage administrator can manage both a physical configuration and a logical configuration exclusive of other storage administrators.

### CROSS-REFERENCES TO RELATED APPLICATIONS

The present application is a continuation application of application Ser. No. 11/176,301, filed Jul. 8, 2005; which relates to and claims priority from Japanese Patent Application No. JP2005-167675, filed on Jun. 8, 2005, the entire disclosure of which is incorporated herein by reference.

### BACKGROUND OF THE INVENTION

The art disclosed in the present specifications relates to a method or system for managing the configuration of a computer system, or more particularly, to a method for managing the configuration of a volume included in a storage system and a management computer for managing the configuration of a volume.

In recent years, an amount of data held in a computer system has drastically increased. A storage area network (SAN) based on a network architecture that numerous host computers and large-scale storage systems are interconnected via a switch is adapted to a computer system in which a growing amount of data is preserved.

One of important duties of storage management required for organizing a computer system is storage configuration management that manages resources of a storage system. Storage configuration management falls broadly into physical configuration management intended for creating or deleting disk (storage) space (hereinafter a volume) to be provided for a host computer or for formatting a volume, and logical configuration management intended for designating an address (small computer system interface (SCSI) path) of a created volume which the host computer accesses to acquire data, or for designating access control so as to limit access to the host computer. Such storage configuration management has a drawback that since the number of volumes that are objects of management increases with an increase in an amount of data, a large load is imposed.

In efforts to overcome the drawback, an art for alleviating the load of storage configuration management has been disclosed in Patent Document 1 (U.S. Patent Publication No. 2004/215879A1), Patent Document 2 (U.S. Patent Publication No. 2003/172069), or the like.

Patent Document 1 has disclosed an art for simplifying physical configuration management, or more particularly, volume creation. Specifically, unallocated volume that has not yet been allocated to a host computer is managed as a “pool.” The pool is used to create a volume in response to a storage administrator's request. This art relieves the storage administrator from being concerned about the details of a configuration such as the disposition of a volume in the storage system.

According to Patent Document 2, when an administrator who supervises or manages a computer system (hereinafter a supervisory storage administrator) assigns logical configuration management to other administrators (hereinafter general storage administrators), the authority to manage a volume can be given volume by volume.

Problems to be solved are illustratively shown in FIG. 24. FIG. 24 shows a computer system which comprises two host computers and three storage systems and in which a supervisory storage administrator ADMS allows two general storage administrators ADM1 and ADM2 who are users to share management. Herein, the general storage administrator ADM1 is in charge of management of a volume to be allocated to a host computer H1, and the general storage administrator ADM2 is in charge of management of a volume to be allocated to a host computer H2.

Assuming that the arts described in Patent Documents 1 and 2 are adapted to the computer system, the general storage administrators ADM1 and ADM2 each use the storage systems ST2, ST3, and ST4 to produce a volume which the administrator needs. Thereafter, each of the general storage administrators gives himself/herself the authority to manage the logical configurations of each volume.

However, the arts described in Patent Documents 1 and 2 cannot give the authority to manage a physical configuration, that is, to create a volume. Consequently, when the general storage administrator ADM1 who is one of users handling components, devices, and resources included in a computer system formats or deletes a volume included in the storage system ST4, the general storage administrator may modify the configuration defined by the general storage administrator ADM2 who is other user, or may lose the configuration defined by the general storage administrator ADM2.

Moreover, normally, a general storage administrator intentionally stops equipment by reason of maintenance of a computer system. In another case, when the general storage administrator ADM1 who is one of users intends to stop the host computer H1 and the storage systems ST2 and ST3, since the storage systems ST2 and ST3 include volumes to be handled by the general storage administrator ADM2, the jobs of the host computer H2 which the general storage administrator ADM2 employs are adversely affected. Consequently, the availability of the entire computer system is degraded.

### SUMMARY OF THE INVENTION

In efforts to solve at least one of the foregoing problems, according to one aspect of the present invention, a computer system comprises one or more storage systems each of which includes a disk device that provides volume in which data to be used by a host computer over a network is stored, and a management computer connected to the one or more storage systems over the network. The management computer receives a request for allocation of volume to a user, and extracts volume, which has not been allocated to any user, from the volumes provided by the plurality of storage systems. Thereafter, the management computer verifies whether an access right permitting access to a storage system providing the extracted volume is granted. If the result of the verification demonstrates that the access right is not granted, the access right permitting access to the storage system is granted to the user, and a volume allocation instruction is transmitted to the storage system. The storage system receives the allocation instruction from the management computer over the network, and allocates the extracted volume to the user.

Other aspects of the present invention for solving at least one of the aforesaid problems will be made apparatus throughout the specifications.

According to the aspects, each of users who manage the configuration of part of a computer system will be unsusceptible to a manipulation any other user performs for modification of a configuration. Consequently, a storage administrator can safely manage the configuration of a storage system. Furthermore, since storage systems to be employed by respective users are different from one another, stoppage of a storage system by reason of scheduled maintenance will not affect other jobs. Eventually, the availability of the entire computer system improves.

### BRIEF DESCRIPTION OF THE DRAWINGS

FIG. 1 shows an example of the configuration of a computer system in accordance with the first embodiment of the present invention;

FIG. 2 shows an example of the detailed configuration of a host computer 10000;

FIG. 3 shows an example of the detailed configuration of a storage system 20000 included in the first embodiment;

FIG. 4 shows an example of the detailed configuration of a management computer 40000 included in the first embodiment;

FIG. 5 shows an example of the detailed configuration of a management terminal 70000;

FIG. 6 shows an example of the structure of a table preserved in the storage system 20000;

FIG. 7 shows an example of the structure of a table preserved in the management computer 40000 included in the first embodiment;

FIG. 8 is a flowchart detailing an administrator creation program 42100;

FIG. 9 is a flowchart detailing a volume allocation program 42200 installed in the first embodiment;

FIG. 10 is a flowchart detailing a volume un-allocation program 42300;

FIG. 11 is a flowchart detailing an access control changing program 42400;

FIG. 12 is a flowchart detailing an administrator deletion program 42500;

FIG. 13 shows a table indicating processes of running the volume allocation program and volume un-allocation program and being employed in the first embodiment;

FIG. 14 shows an example of an input/output screen image presented by a program;

FIG. 15 shows an example of the configuration of a computer system in accordance with the second embodiment;

FIG. 16 shows an example of the detailed configuration of a storage system 20001 included in the second embodiment;

FIG. 17 shows an example of the detailed configuration of a management computer 40001 included in the second embodiment;

FIG. 18 shows an example of the structure of a table preserved in the storage system 20001 included in the second embodiment;

FIG. 19 shows an example of the structure of a table preserved in the management computer 40001 included in the second embodiment;

FIG. 20 is a flowchart detailing a volume allocation program 42201 installed in the second embodiment;

FIG. 21 shows an example of another configuration of the computer system in accordance with the second embodiment;

FIG. 22 shows an example of the detailed construction of a switch 30000 included in the configuration of the computer system in accordance with the second embodiment which is shown in FIG. 21;

FIG. 23 illustratively shows the outline of a working mode; and

FIG. 24 illustratively shows problems to be solved.

### DESCRIPTION OF THE PREFERRED EMBODIMENTS

Referring to the drawings, embodiments of the present invention will be described below. Noted is that the present invention will not be limited to the description to be made below. Hereinafter, a supervisory storage administrator will be referred to as a supervisory administrator, and a general storage administrator will be referred to as a general administrator. When the supervisory administrator need not be discriminated from the general administrator, both of the supervisory administrator and general administrator will be referred to as an administrator.

### First Embodiment

### (1) System Configuration of a Computer System in Accordance with the First Embodiment

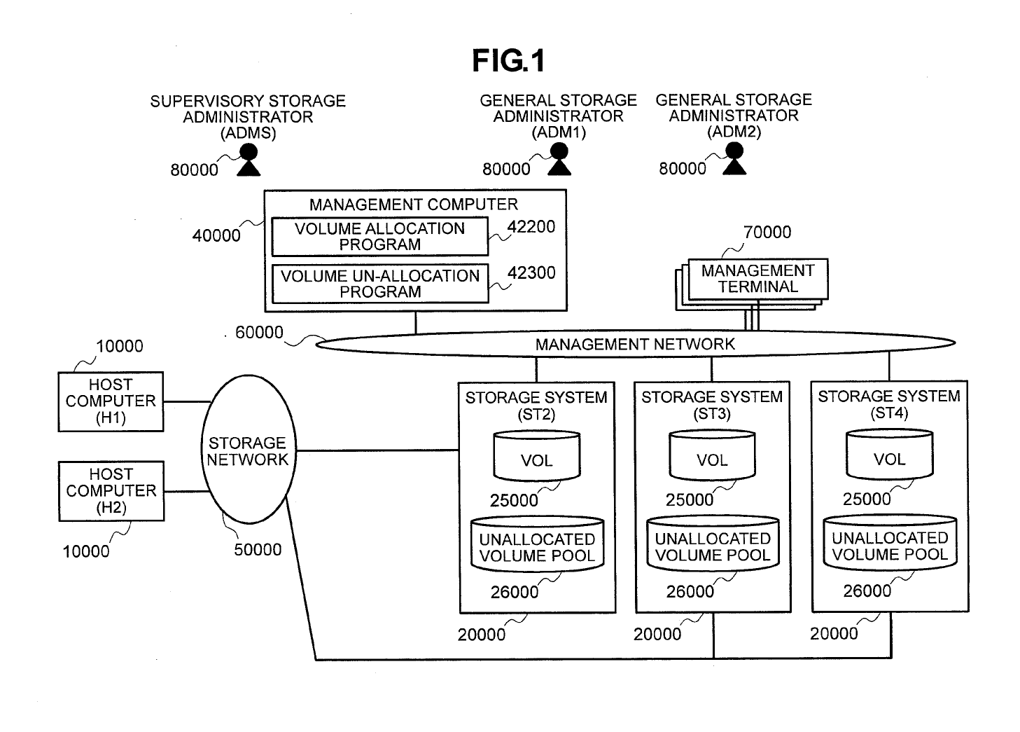

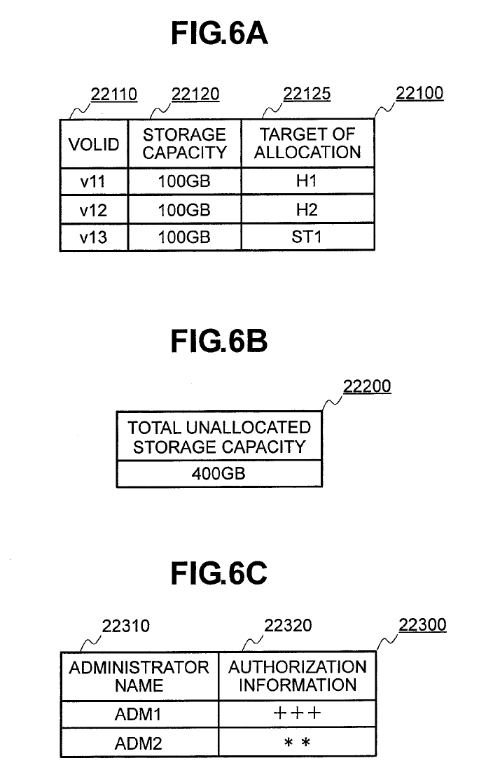

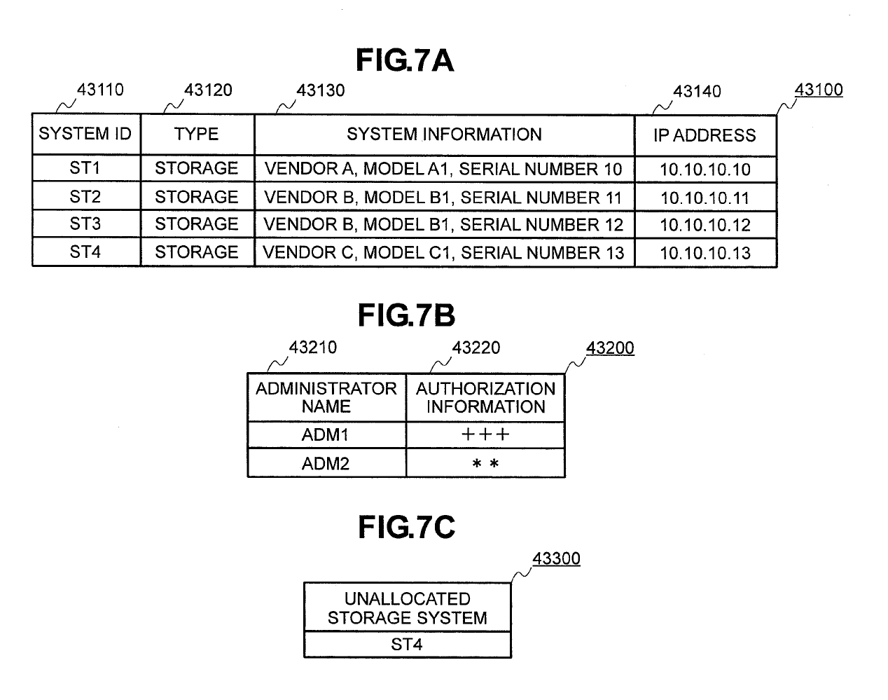

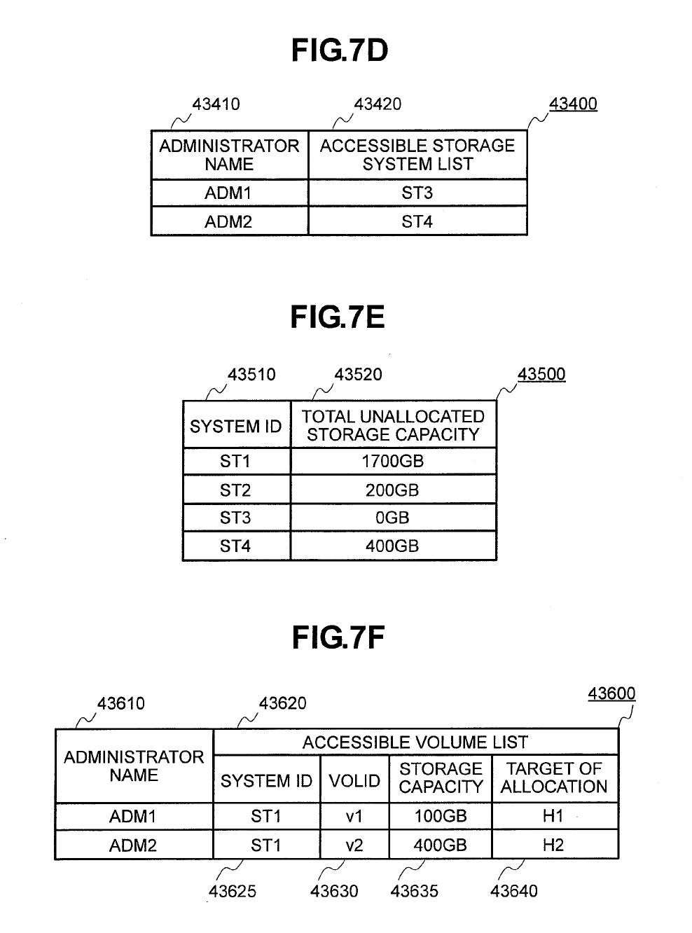

The configuration of a computer system in accordance with the first embodiment will be described below. FIG. 1 to FIG. 5 show the configuration of the computer system and the configurations of pieces of equipment interconnected in the computer system. FIG. 6A to FIG. 7F show pieces of management information preserved in the pieces of equipment.

FIG. 1 shows the configuration of the computer system. One or more host computers 10000 and one or more storage systems 20000 are connected to each other over a storage network 50000. Moreover, the storage systems 20000 are connected to a management computer 40000 and a management terminal 70000 over a management network 60000. Herein, the management terminal 70000 is a terminal which an administrator 80000 uses to run a program, which is installed in the management computer 60000, from a remote place. The administrator 80000 may use the management terminal 70000 to run a program installed in the management computer 60000 or may directly manipulate the management computer to run the program. Furthermore, over the storage network 50000 over which the host computers and the storage systems are connected to each other and over which the storage systems are interconnected, these pieces of equipment may be directly interconnected without a switch 30000.

For convenience' sake, in the first embodiment, the host computers H1 and H2 shall be connected to the storage systems ST2, ST3, and ST4 over the storage network. Moreover, the storage network 50000 shall be a network adopting a Fibre channel (FC) protocol, and the management network 60000 shall be a network adopting an IP protocol. Moreover, a supervisory administrator 80000 of the computer system has a name of ADMS, and two general administrators 80000 have names of ADM1 and ADM2.

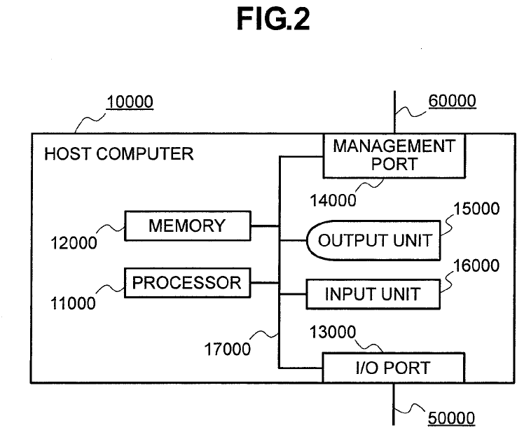

FIG. 2 shows an example of the detailed configuration of the host computer 10000. The host computer 10000 comprises a processor 11000, a memory 12000, one or more input/output ports 13000 via which the host computer is connected on the storage network 50000, a management port 14000 via which the host computer is connected on the management network 60000, an output unit 15000 that is a display device or the like to which a result of processing is transmitted, and an input unit 16000 that is a keyboard and a mouse. These components are interconnected over an internal bus 17000. An operating system (OS) and an application program that performs processing including access to data in a logical unit (LU) are loaded from a storage medium (not shown) such as a hard disk into the memory 12000, though the operating system and application program are not shown. When the processor 11000 runs the program, data is read or written in or from a logical unit.

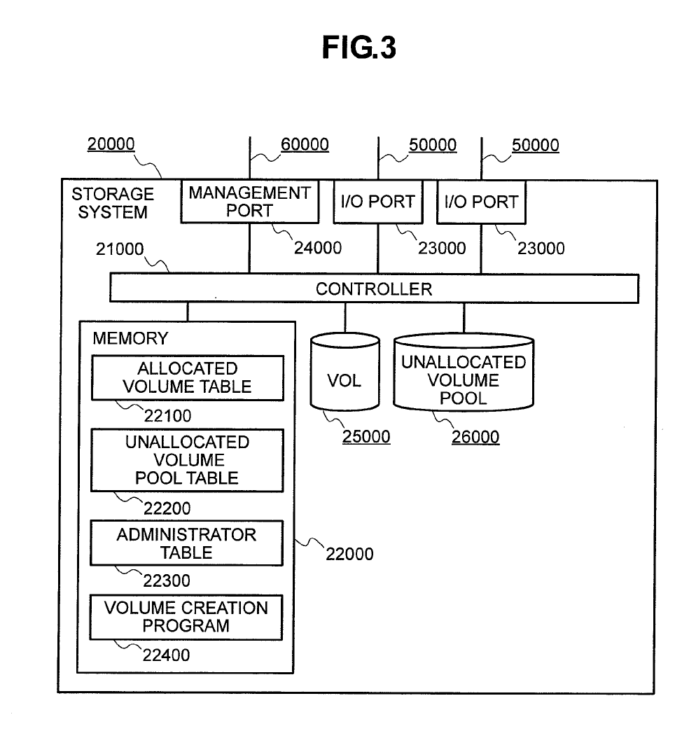

FIG. 3 shows an example of the detailed configuration of the storage system 20000. The storage system 20000 comprises a controller 21000 that controls the internal components of the storage system, one or more input/output ports 23000 via which the storage system is connected on the storage network 50000, a management port 24000 via which the storage system is connected on the management network 60000, and one or more volumes 25000 serving as logical units allocated to a host computer (which may be called a logical volume or a logical storage area), and an unallocated volume pool 26000 that is at least one of volumes is not allocated to any host computer (which may be called a logical volume or a logical storage area). These components of the storage system are interconnected via the controller 21000. Stored in a program memory 22000 are a control program (not shown) that controls the internal components of the storage system, an allocated volume table 22100 for use in managing the volume 25000 included in the storage system, an unallocated volume pool table 22200 for use in managing the unallocated volume pool 26000 included in the storage system, an administrator table 22300 holding pieces of information on administrators who can manage the configuration of the storage system, and a volume creation program 22400 that treats a request for creation of a volume in the storage system or a request for cancellation of creation which is issued from the management computer 40000. When the storage system is started, the tables and programs are loaded from a storage medium (not shown) such as a hard disk and handled by the controller.

In the present invention, the number of input/output ports 23000 and the number of volumes 26000 and the storage capacity thereof do not count. Moreover, the volume 26000 may span a plurality of hard disks having a configuration of redundant array of inexpensive disks (RAID) or may be realized with one hard disk.

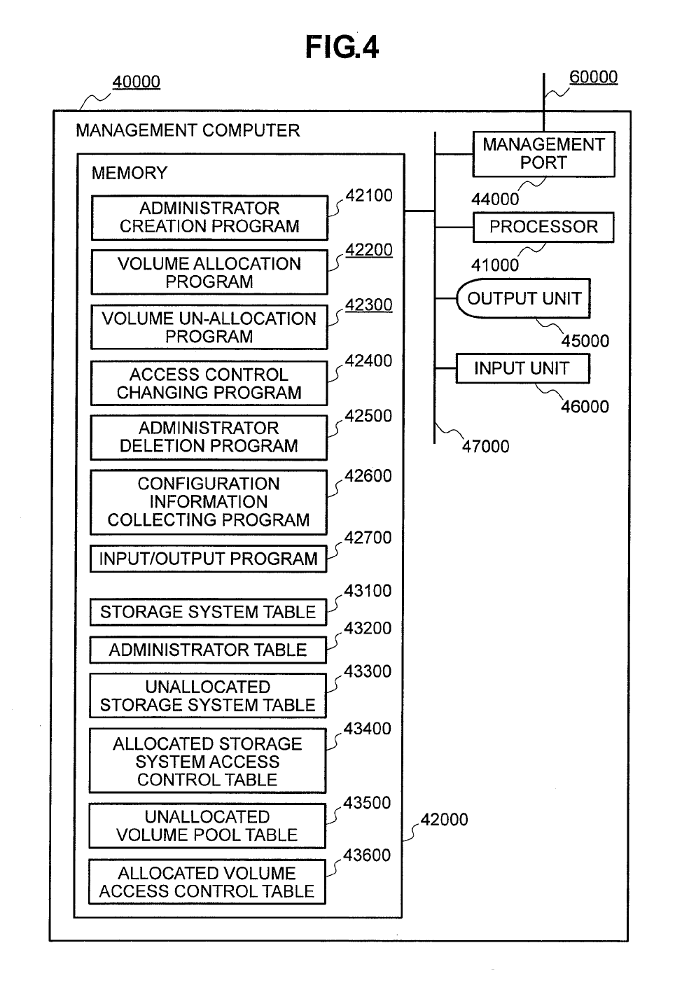

FIG. 4 shows the detailed configuration of the management computer 40000. The management computer 40000 comprises a processor 41000, a memory 42000, a management port 44000 via which the management computer is connected on the management network 60000, an output unit 45000 that is a display device or the like to which a result of processing is transmitted, and an input unit 46000 that is a keyboard and a mouse. These components are interconnected over an internal bus 47000. Stored in the memory 42000 are an administrator creation program 42100, a volume allocation program 42200, a volume un-allocation program 42300, an access control changing program 42400, an administrator deletion program 42500, a configuration information collecting program 42600, an input/output program 42700, a system table 43100 which the management computer 40000 references in order to identify the storage system 20000 that is an object of management, an administrator table 43200 holding pieces of information on administrators capable of managing the configuration of a storage system, an unallocated storage system table 43300 for use in managing a storage system that does not include a volume allocated to a host computer and does not give any general administrator the authority to manage the physical configuration thereof, an allocated storage system access control table 43400 for use in managing a storage system that includes a volume allocated to a host computer and that has given a certain general administrator the authority to manage the physical configuration thereof, an unallocated volume pool table 43500 for use in managing volumes unallocated to host computers, and an allocated volume access control table 43600 for use in managing volumes allocated to host computers. These programs and tables that will be described later are loaded from a storage medium (not shown) such as a hard disk to the memory 42000. The programs are then run. Moreover, an operating system (OS) is loaded from a storage medium to the memory 42000. The processor 11000 runs the programs.

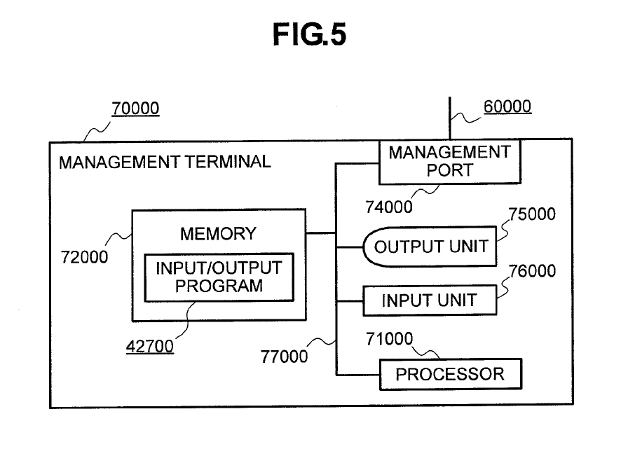

FIG. 5 shows the detailed configuration of the management terminal 70000. The management terminal 70000 comprises a processor 71000, a memory 72000, a management port 74000 via which the management terminal is connected on the management network 60000, an output unit 75000 that is a display device or the like to which a result of processing is transmitted, and an input unit 76000 that is a keyboard and a mouse. These components are interconnected over an internal bus 77000. An input/output program 42700 that controls an input and an output transferred in order to run a program installed in the management computer 60000 from a remote place is stored in the memory 72000. The input/output program is loaded from a storage medium (not shown) such as a hard disk to the memory 72000, and then run by the processor 41000. Moreover, an operating system (OS) is loaded from a storage medium (not shown) such as a hard disk into the memory 72000, though the OS is not shown. The processor 71000 runs the programs.

FIG. 6A, FIG. 6B, and FIG. 6C show examples of tables preserved in the storage system 20000.

FIG. 6A shows an example of the allocated volume table 22100 for use in managing the volume 25000 included in the storage system 20000. The allocated volume management table 22100 comprises a field 22110 in which volume IDs that are unique identifiers of volumes included in the storage system are registered, a field 22120 in which the storage capacities of the volumes are registered, and a field 22125 in which host computers to which the respective volumes are allocated are registered.

FIG. 6B shows an example of the unallocated volume pool table 22200 for use in managing an unallocated volume pool 26000 included in the storage system 20000. The unallocated volume pool table 22200 has only a field in which the total storage capacity of unallocated volume is registered.

FIG. 6C shows an example of the administrator table 22300 holding pieces of information on administrators capable of managing the configuration of the storage system 20000. The administrator table 22300 comprises a field 22310 in which names of administrators to be used to log in a program to be described later (volume creation program) are registered, and a field 22320 in which pieces of authorization information which the respective administrators use for login are registered.

FIG. 7A, FIG. 7B, FIG. 7C, FIG. 7D, FIG. 7E, and FIG. 7F show examples of tables preserved in the management computer 40000.

FIG. 7A shows an example of the system table 43100 which the management computer 40000 references in order to identify a storage system 20000 that is an object of management. The system table 43100 comprises a field 43110 in which system IDs that are identifiers with which storage systems that are objects of detection are uniquely discriminated from one another within the management computer 40000 are registered, a field 43120 in which types of storage systems that are objects of detection are registered, a field 43130 in which pieces of information on storage systems with which the storage systems are uniquely discriminated from one another and each of which includes a vendor name, a model name, or a serial number of each storage system that is an object of detection are registered, and a field 43140 in which IP addresses required for connection of the respective storage systems that are objects of detection via the management port are registered. Incidentally, a supervisory administrator may register the pieces of information in advance using the management computer 40000 or management terminal 70000. Moreover, a name server for translating names from one form to another on the storage network or management network may be used to automatically produce IP addresses or the like.

FIG. 7B shows an example of the administrator table 53200 holding pieces of information on administrators capable of managing the configuration of the storage system 20000. The administrator table 53200 comprises a field 43210 in which administrator names to be used to log in a program that will be described later are registered, and a field 43220 in which pieces of authorization information which the respective administrators use for login are registered.

FIG. 7C shows an example of the unallocated storage system table 43300 for use in managing a storage system that has no volume 25000 allocated to the host computer 10000 and that has not given any general administrator 80000 the authority to manage the physical configuration thereof. The unallocated storage system table 43300 of this example holds an attribute of an unallocated volume. The unallocated storage system table 43300 has only a field in which an unallocated storage system is registered.

FIG. 7D shows an example of the allocated storage system access control table 43400 for use in managing the storage systems 20000 that each have a volume 25000 allocated to a host computer 10000 and that each have given a certain general administrator 80000 the authority to manage the physical configuration thereof. The allocated storage system access control table 43400 comprises a field 43410 in which names of administrators each given the authority to manage the configuration of a storage system are registered, and a field 43420 in which system IDs of storage systems 20000 (accessible storage systems) which have the authority to manage the configurations thereof given to the associated administrator are registered.

FIG. 7E shows an example of the unallocated volume pool table 43500 for use in managing volumes 25000 allocated to the host computers 10000. The unallocated volume pool table 43500 comprises a field 43510 in which system IDs of storage systems 20000 that each have the unallocated volume pool 26000 are registered, and a field 43520 in which the total unallocated storage capacities of the respective storage systems 20000 are registered.

FIG. 7F shows an example of the allocated volume access control table 43600 for use in managing volumes 25000 allocated to the host computers 10000. Attributes of the volumes are held in the allocated volume access control table 43600. The allocated volume access control table 43600 comprises a field 43610 in which names of administrators each given the authority to manage the configuration of an associated storage system are registered, and a field 43620 in which volumes 25000 (accessible volumes) that each have the authority to manage the configuration thereof given to the associated administrator are registered. The accessible volume list field 43620 comprises a field 43625 in which system IDs of storage systems 20000 each offering an associated volume are registered, a field 43630 in which volume IDs of respective volumes are registered, a field 43635 in which storage capacities each offered by an associated volume are registered, and a field 43640 in which host computers to each of which an associated volume is allocated are registered.

### (2) Flowcharts Describing Programs Installed in the First Embodiment

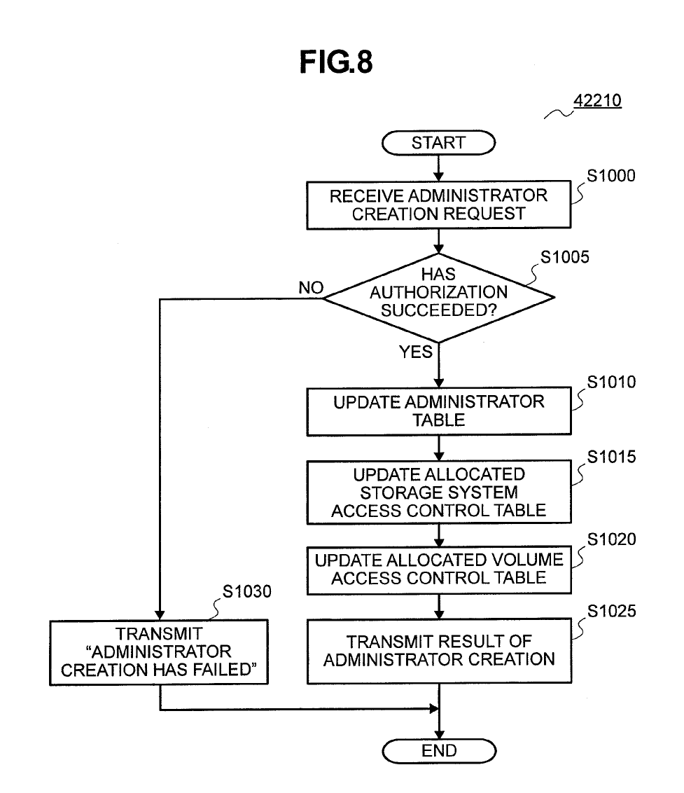

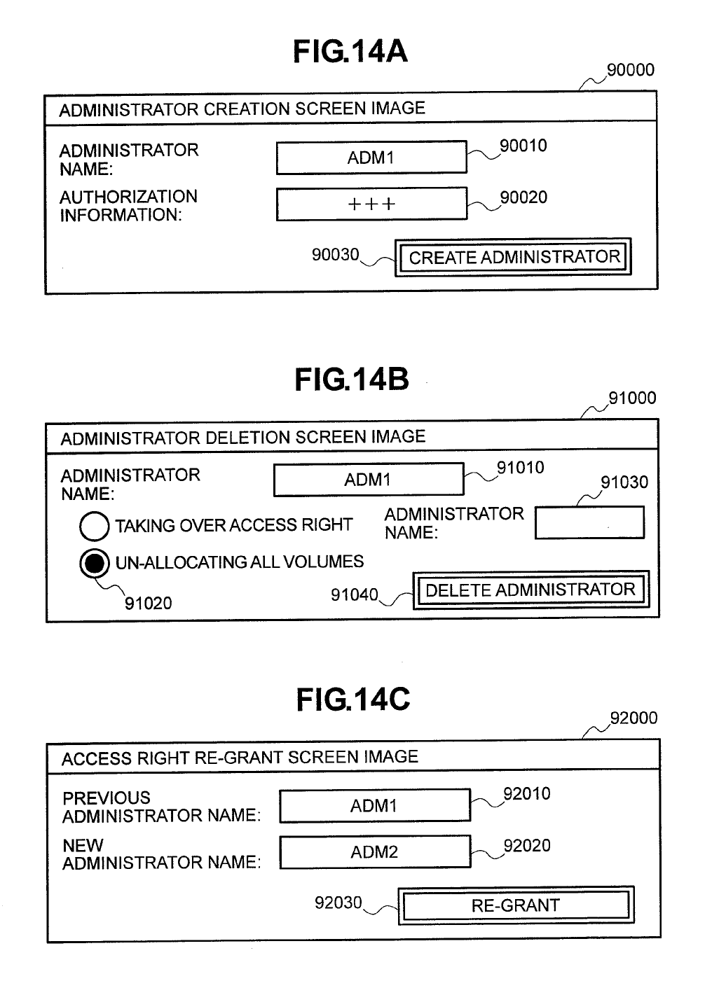

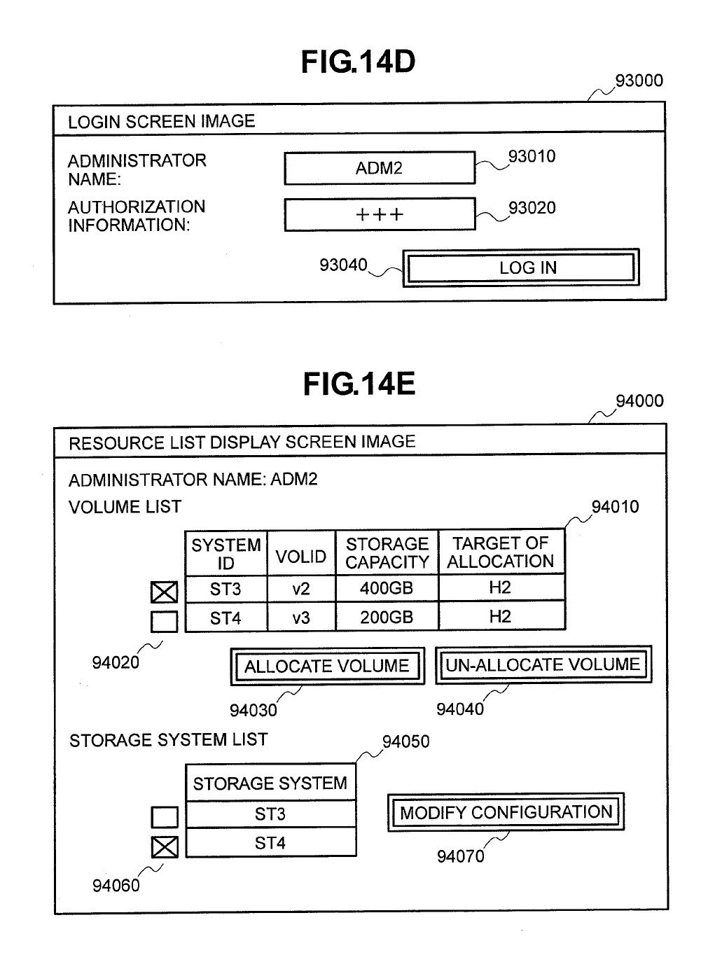

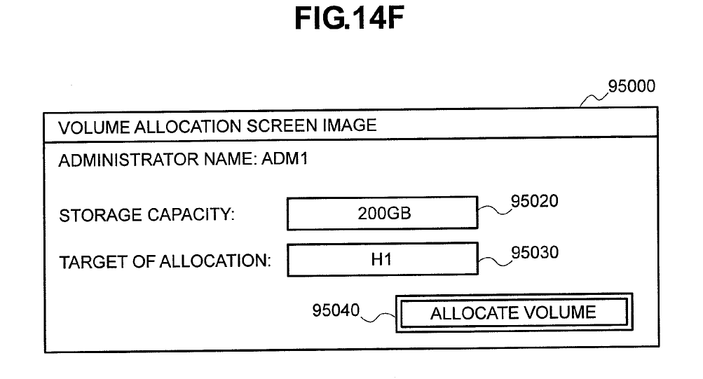

Next, control flows to be implemented by programs that are run by the management computer 40000 installed in the first embodiment will be described using the flowcharts of FIG. 8 to FIG. 12 and an example of an output screen image shown in FIG. 14. To begin with, the configuration information collecting program 42600 and input/output program 42700 whose control flows are not shown will be described below.

The configuration information collecting program 42600 is regularly run by the management computer 40000 in order to collect configuration information from each of the storage systems 20000 that are objects of management. Otherwise, the configuration information collecting program 42600 is run by the management computer 40000 in response to an instruction given by an administrator 80000. Specifically, a configuration information acquisition instruction is issued to the plurality of storage systems 20000, which is registered in the system table 43100, using the IP addresses for the respective storage systems 2000 registered in the IP address field 43140. The values specified in the allocated volume table 22100 and the unallocated volume pool table 22200 preserved in each of the storage systems 20000 are acquired. The management computer 40000 copies the acquired values specified in the allocated volume table 22100 into the associated field in the allocated volume access control table 43600 preserved in the management computer 40000. Moreover, the management computer 40000 copies the values in the unallocated volume pool table 22200 into the associated field in the unallocated volume pool table 43500 preserved in the management computer 40000. Owing to the configuration information collecting program, the management computer 40000 can update the values represented by the pieces of configuration information on the storage systems 20000 and held in the management computer 40000.

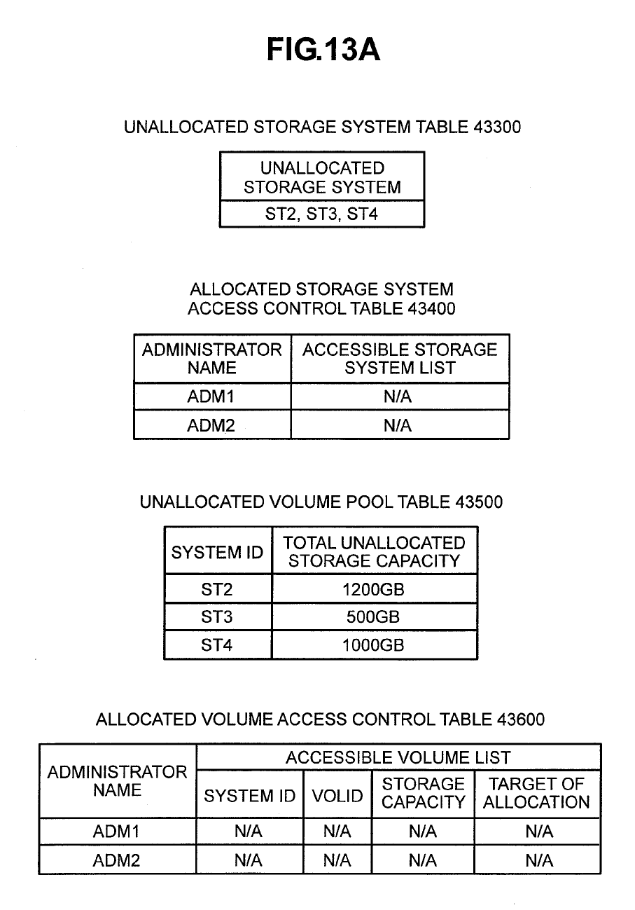

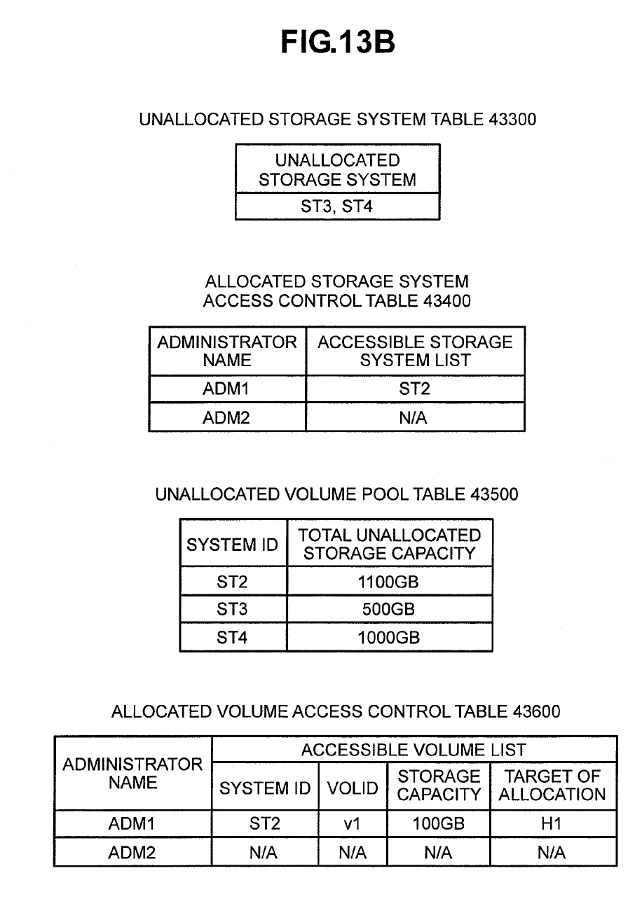

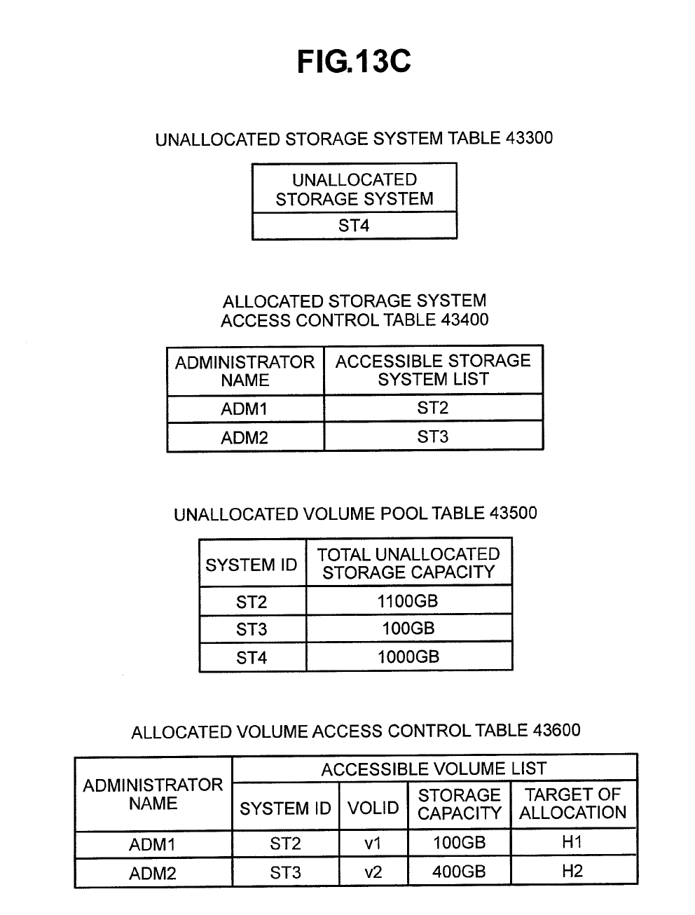

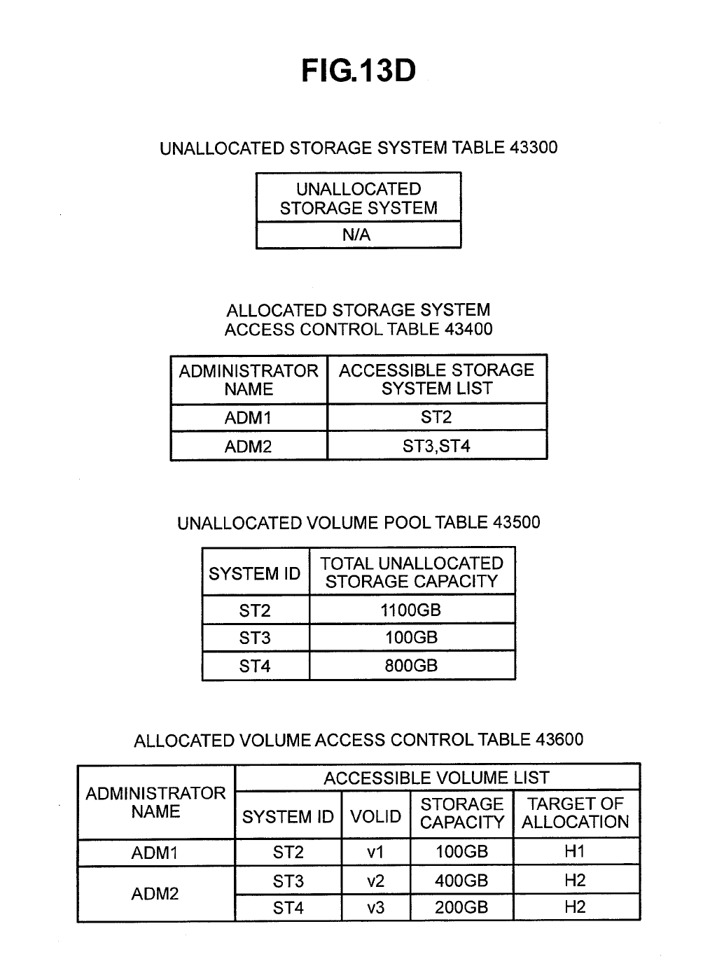

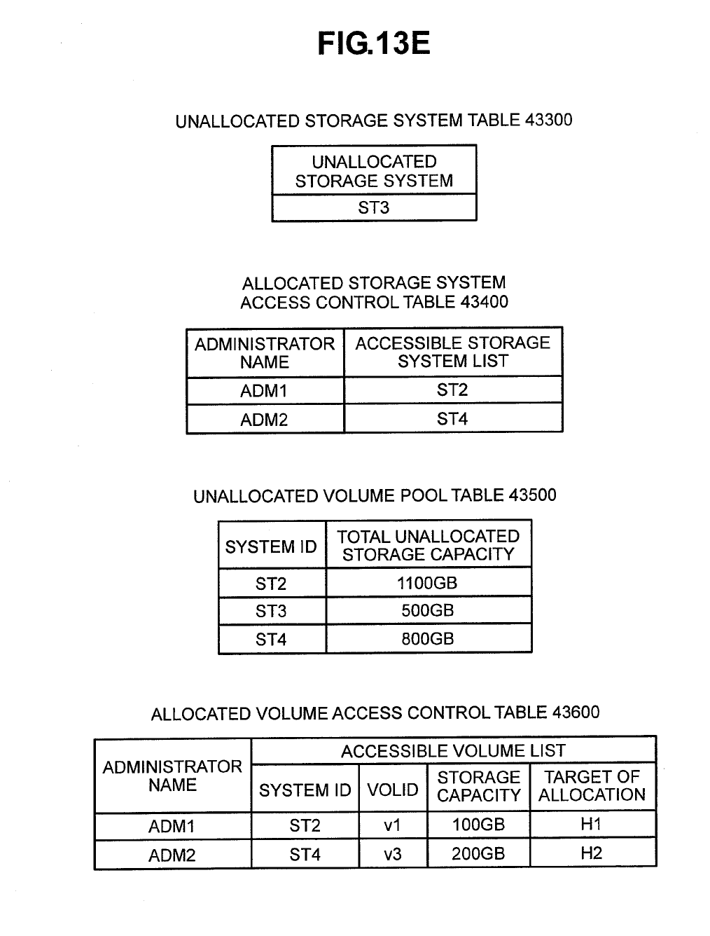

The input/output program 42700 transmits an input request, which requests reception of the administrator creation program 42100, volume allocation program 42200, volume un-allocation program 42300, access control changing program 42400, or administrator deletion program 42500, to the output unit included in the management computer 40000 or management terminal 70000. An administrator 80000 receives an instruction of running the input/output program 42700, and initiates the program. In the present embodiment of the present invention, the input request will be, as described later, displayed on a screen as shown in FIG. 13. However, the input request is not limited to this one. Alternatively, a designative filename may be entered in order to initiate batch processing or a command may be issued in order to initiate processing.

Next, the control flows to be implemented by the programs (2a) to (2e) will be described orderly.

(2a) Administrator Creation Program 42100

FIG. 8 is a flowchart of the administrator creation program 42100. The supervisory administrator 80000 uses the administrator creation program 42100 to produce information on a general administrator who will manage the configuration of a computer system, and the management computer 4000 runs the administrator creation program 42100.

Prior to the implementation of the control flow described in FIG. 8, the input/output program 42700 displays a login screen image 93000 like the one shown in FIG. 14D so as to acquire authorization information on the supervisory administrator 80000. Moreover, the input/output program 42700 displays an administrator creation screen image 90000 like the one shown in FIG. 14A. The supervisory administrator 80000 enters an administrator name 90010 which the general administrator 80000, information on whom is about to be produced, uses to log in the management computer 40000, and authorization information 90020 which the general administrator 80000 is requested to enter for login. When the supervisory administrator 80000 depresses a Create Administrator button 90030, the administrator creation program 42100 is initiated.

First, the management computer 40000 receives an administrator creation request from the input/output program 42700 (step S1000). Specifically, the administrator creation request includes information on the supervisory administrator who has instructed run of the administrator creation program 42700 and whose name is acquired from the login screen image 93000, and information on a general administrator, whose name is acquired from the administrator creation screen image 90000, to be newly produced.

After receiving the creation request, the management computer 40000 uses the information on the supervisory administrator to verify whether the creation request should be treated, that is, whether the supervisory administrator can be authorized (step S1005). Specifically, the management computer 40000 checks the supervisory administrator information to see if it is consistent with the name of the supervisory administrator 80000 and the authorization information on the supervisory administrator which are specified in the administrator table 43200. If the supervisory administrator information is inconsistent with them, Administrator Creation Has Failed is transmitted (step S1030) and the administrator creation program 42100 is terminated.

If authorization succeeds at step S1005, the management computer 40000 updates the administrator table so as to append information on a general administrator (step S1010). Specifically, a new entry is appended to the administrator table, and new information on a general administrator is registered.

Thereafter, the management computer 40000 updates the allocated storage system access control table 43400 so as to append information on a general administrator (step S1015). Specifically, a new entry is appended to the allocated storage system access control table 43400, and the name of the general administrator information on whom is newly produced is registered in the administrator name field 43410. Not Applicable (N/A) signifying that the general administrator has not yet been given the authority to manage any storage system is registered in the accessible storage system list field 43420.

Thereafter, the management computer 40000 updates the allocated volume access control table 43600 so as to append the information on the general administrator (step S1020). Specifically, a new entry is appended to the allocated storage system access control table 43600 in order to register the name of the general administrator, information on whom is newly produced, in the administrator name field 43610. Not Applicable (N/A) signifying that the general administrator has not yet been given the authority to manage the configuration of any storage system is registered in the accessible storage system list field 43620.

Finally, the management computer 40000 transmits a result indicating that administrator creation has succeeded (step S1025), and terminates the program.

The control flow to be implemented by the administrator creation program 42100 has been described so far.

(2b) Volume Allocation Program 42200

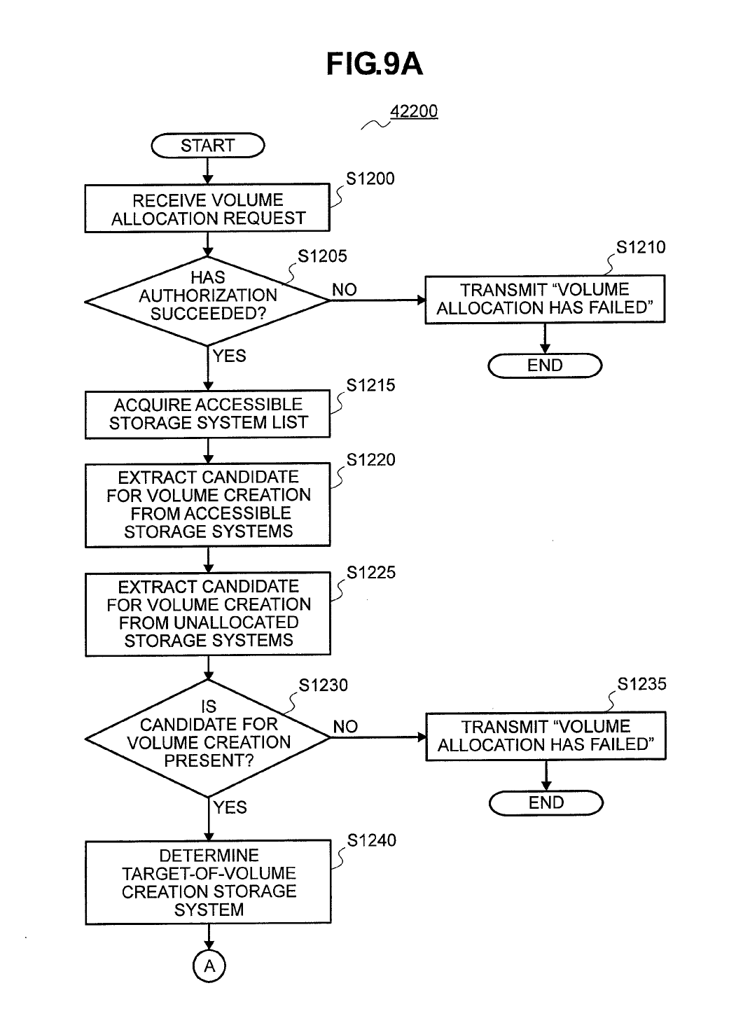

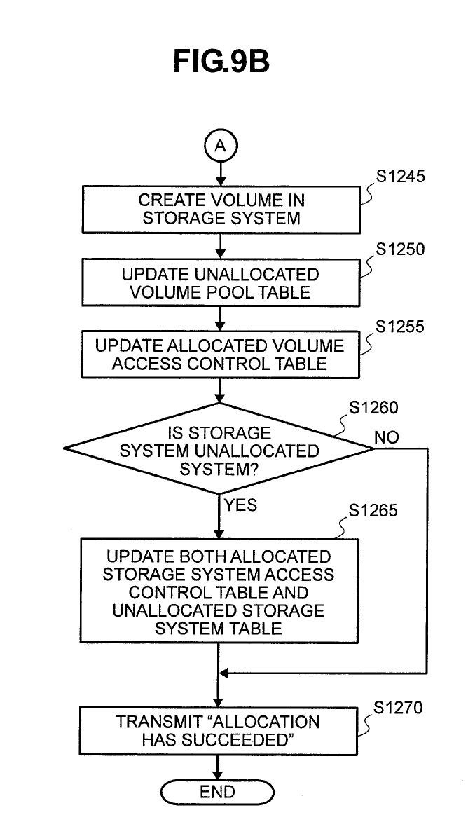

FIG. 9A and FIG. 9B are flowcharts describing the volume allocation program 42200. The general administrator 80000 uses the volume allocation program 42200 to allocate a volume to a host computer, and the management computer 40000 runs the volume allocation program 42200. Within the volume allocation program, the management computer 40000 gives the general administrator 80000, who has instructed allocation, the authority to manage the logical configuration of a volume 2500 to be allocated and the authority to manage the physical configuration of a storage system 20000 including the volume.

Prior to the implementation of the control flow described in FIG. 8, the input/output program 42700 displays a login screen image 93000 like the one shown in FIG. 14D so as to acquire authorization information on the supervisory administrator 80000 including Administrator Name 93010 and Authorization Information 93020. Once the Administrator Name 93010 and Authorization Information 93020 has been input, the administrator depresses the login button 93040 to effect login. Moreover, the input/output program 42700 displays an administrator creation screen image 90000 like the one shown in FIG. 14A. The supervisory administrator 80000 enters an administrator name 90010 which the general administrator 80000, information on whom is about to be produced, uses to log in the management computer 40000, and authorization information 90020 which the general administrator 80000 is requested to enter for login. When the supervisory administrator 80000 depresses a Create Administrator button 90030, the administrator creation program 42100 is initiated.

According to the present embodiment, parameters designated by the general administrator 80000 include the storage capacity of a volume and the name of a target-of-allocation host computer. Depending on configuration information provided by a storage system, a RAID level of a volume to be created, a frequency band supported by an input/output port, or any other parameter relevant to the performance of the volume may be able to be designated. Moreover, a storage system in which a volume to be allocated is created may be able to be selected.

To begin with, the processor 4100 included in the management computer 40000 receives a volume allocation request from the input/output program 42700 (step S1200). Specifically, the volume allocation request includes information on a general administrator, who has instructed run of the volume allocation program 42200, acquired from the login screen image 93000, and information on a new general administrator, information on whom is newly produced, acquired from the volume allocation screen image 95000.

After receiving the volume allocation request, the processor 41000 uses the information on the general administrator to verify whether the volume allocation request should be treated, that is, whether the general administrator is authorized (step S1205). Specifically, the processor 41000 checks the general administrator information to see if it is consistent with the name of the general administrator 80000 and the authorization information on the general administrator which are specified in the administrator table 43200. If the general administrator information is inconsistent, Volume Allocation Has Failed is transmitted (step S1210), and the volume allocation program 42200 is terminated.

If authorization succeeds at step S1205, the processor 41000 acquires a list of storage systems having the authority to manage the configurations thereof given to the general administrator (in other words, storage systems accessible to the general administrator) (step S1215). Specifically, the allocated storage system access control table 43400 is searched for an entry consistent with the name of the general administrator. The accessible storage system list field 43420 is referenced in association with the entry in order to acquire information on a storage system that is an object of access control.

Thereafter, the processor 41000 extracts a candidate for volume creation from the accessible storage systems 20000 information on which is acquired at step S1215 (step S1220). Specifically, all the system IDs of the accessible storage systems 20000 acquired at step S1215 are checked to see if they are consistent with the entries of the unallocated volume pool table 43500. The value specified in the total unallocated storage capacity field 43520 in association with a consistent entry is checked to see if it is equal to or larger than the allocated volume storage capacity 95020. If the value is equal to or larger than the allocated volume storage capacity 95020, the associated storage system is recognized to be able to be allocated. The storage system is extracted as a candidate for volume creation. Incidentally, a plurality of storage systems may be extracted as candidates for volume creation.

Thereafter, the processor 41000 extracts a candidate for volume creation from unallocated storage systems (S1225). Specifically, all pieces of information on storage systems 20000 specified in the unallocated storage system table 43300 are retrieved. The value specified in the entry for a storage system, which corresponds to a storage system information on which is retrieved, in the total unallocated storage capacity field 43520 in the unallocated volume pool table 43500 is checked to see if it is equal to or larger than the value of the allocated volume storage capacity 95020. If the value in the total unallocated storage capacity field 43520 is equal to or larger than the value of the allocated volume storage capacity 95020, the associated storage system is recognized to be able to be allocated. The storage system is then extracted as a candidate for volume creation. Incidentally, the candidate for volume creation may include a plurality of storage systems.

Thereafter, the processor 41000 verifies whether a candidate for volume creation is selected at steps S1220 and S1225 (step S1230). If a storage system serving as a candidate for volume creation is not found at all, Volume Allocation Has Failed is displayed (step S1235). The volume allocation program 42200 is then terminated.

If presence of a storage system serving as a candidate for volume creation is recognized at step S1230, a target-of-volume creation storage system 20000 is determined (step S1240). For determination of a storage system, the volume allocation program 42200 may select any accessible storage system 20000 with priority given thereto. Otherwise, the volume allocation program 42200 may select any storage system from among all candidates including accessible storage systems and unallocated storage systems. Otherwise, the input/output program 42700 may be used to prompt the general administrator 80000 to select any storage system 20000.

After a target-of-volume creation storage system 20000 is determined at step S1240, the processor 41000 instructs the target-of-volume creation storage system 20000 to create a volume (step S1245). Specifically, the processor 41000 issues a volume creation instruction to the target-of-volume creation storage system 20000 over the management network 60000 while adopting as parameters information on a general administrator who has instructed run of the volume allocation program 42200, the allocated volume storage capacity 95020, and the name of the target-of-allocation host computer 95030. In response to the instruction, the target-of-volume creation storage system 20000 runs the volume creation program 22400. Thus, a volume 25000 is created, the allocated volume table 22100 is updated, and the unallocated volume pool table 22200 is updated. Information on an entry for the created volume included in the allocated volume table 22100, which signifies a success in volume creation, is returned to the management computer 40000. The processor 41000 receives the information on the entry for the created volume in the allocated volume table 22100. The step S1245 is terminated.

At the step S1245, if a volume is created using an unallocated storage system, before a volume creation instruction is issued, information on the supervisory administrator 80000 is used to issue an instruction that an entry for a general administrator who has instructed run of the volume allocation program 42200 should be appended to the administrator table 22300 preserved in the storage system. After the entry for the administrator is appended, the information on the general administrator who has instructed run of the volume allocation program 42200 may be used to issue the volume creation instruction. Otherwise, the management computer 40000 may issue both the volume creation instruction and the instruction, which instructs that an entry for a general administrator should be appended, to the unallocated storage system.

After a volume is created in a storage system at step S1245, the processor 41000 updates the unallocated volume pool table 43500 (step S1250). Specifically, the unallocated volume pool table 43500 is searched for the entry for the target-of-volume creation storage system 20000, and the value specified in the total unallocated storage capacity field 43520 in association with the entry is updated by subtracting the value of the unallocated volume storage capacity 95020 therefrom.

Thereafter, the processor 41000 updates the allocated volume access control table 43600 so as to give the general administrator, who has requested allocation, the authority to manage the logical configuration of a newly allocated volume (step S1255). Specifically, the processor 41000 searches the allocated volume access control table 43600 for the entry for the general administrator on the basis of authorization information on the general administrator acquired at step S1200. The processor 4100 then registers the system ID of the target-of-volume creation storage system in the accessible volume list field 43600, and registers information in the entry for the created volume in the allocated volume table 22100.

Thereafter, the processor 41000 verifies whether the target-of-volume creation storage system 20000 is an unallocated system (step S1260). Specifically, the processor 41000 checks the system ID of the target-of-volume creation storage system to see if it is present in the unallocated storage system table 43300. If the system ID is present, the target-of-volume creation storage system is recognized as an unallocated storage system, control is jumped to step S1265. If the system ID is absent, the target-of-volume creation storage system is recognized as an accessible storage system, control is jumped to step S1270.

If the target-of-volume creation storage system is recognized as an unallocated storage system at step S1260, the processor 41000 updates the allocated storage system access control table 43400 and the unallocated storage system table 43300 so as to give the general administrator, who has requested allocation, the authority to manage the physical configuration of the unallocated storage system (step S1265). Specifically, the processor 41000 deletes the entry for the target-of-volume creation storage system from the unallocated storage system table 43300. Moreover, based on the authorization information on the general administrator acquired at step S1200, the processor 41000 searches the allocated storage system access control table 43400 for the entry for the general administrator, and appends the system ID of the target-of-volume creation storage system to the accessible storage system list field 43420.

Finally, the processor 41000 included in the management computer 40000 transmits a result, which signifies a success in volume allocation, to the output unit 45000 (step S1270). and then terminates the program.

An example of a transmitted result is a resource list display screen image 94010 like the one shown in FIG. 14E. For example, a list of volumes having the authority to manage the logical configurations thereof given to the general administrator 80000 is displayed in a volume list display area 94010. In the volume list display area 94010, information retrieved from the entry for the general administrator 80000 in the allocated volume access control table 43600 is displayed. Thus, the information retrieved from the entry for the general administrator 80000 in the allocated volume access control table 43600 is displayed, and the general administrator is regarded as an administrator who may be selected for management of a logical configuration. Consequently, logical configuration management will not be performed on the same volume as the volume whose logical configuration is managed by other general administrator, that is, logical configuration management will not compete with logical configuration management performed by other general administrator. Thus, logical configuration management can be provided.

Moreover, a list of storage systems 20000 having the authority to manage the physical configurations thereof given to the general administrator 80000 is displayed in a storage system list display area 94050. In the storage system list display area 94050, information retrieved from the entry for the general administrator 80000 in the allocated storage system access control table 43400 is displayed to indicate a particular one of the storage systems in which its configuration is to be modified, check boxes 94060 are produced in association with respective entries for storage systems in the storage system list display area 94050. After a check is entered in any one of the checked boxes 94060, a modified configuration button 94070 is depressed. Consequently, the storage system having the check entered in the associated check box 94060 is regarded as an object of configuration modification. The modification of the object storage system is then initiated. The information retrieved from the entry for the general administrator 80000 in the allocated storage system access control table 43400 is displayed, and the general administrator is regarded as an administrator who may be selected for management of a physical configuration. Consequently, physical configuration management will not be performed on the same storage system as the storage system whose physical configuration is managed by other general administrator, that is, physical configuration management will not compete with physical configuration management performed by other general administrator. Thus, physical configuration management can be achieved.

Furthermore, another example of a transmitted result is such that the management computer notifies a host computer of the fact that volume allocation has succeeded. If the host computer issues an OS volume re-discovery command in response to the notification, the procedure according to which an administrator allocates a new volume to a host computer is simplified.

The control flow to be implemented by the volume allocation program 42200 has been described so far.

(2c) Volume Un-Allocation Program 42300

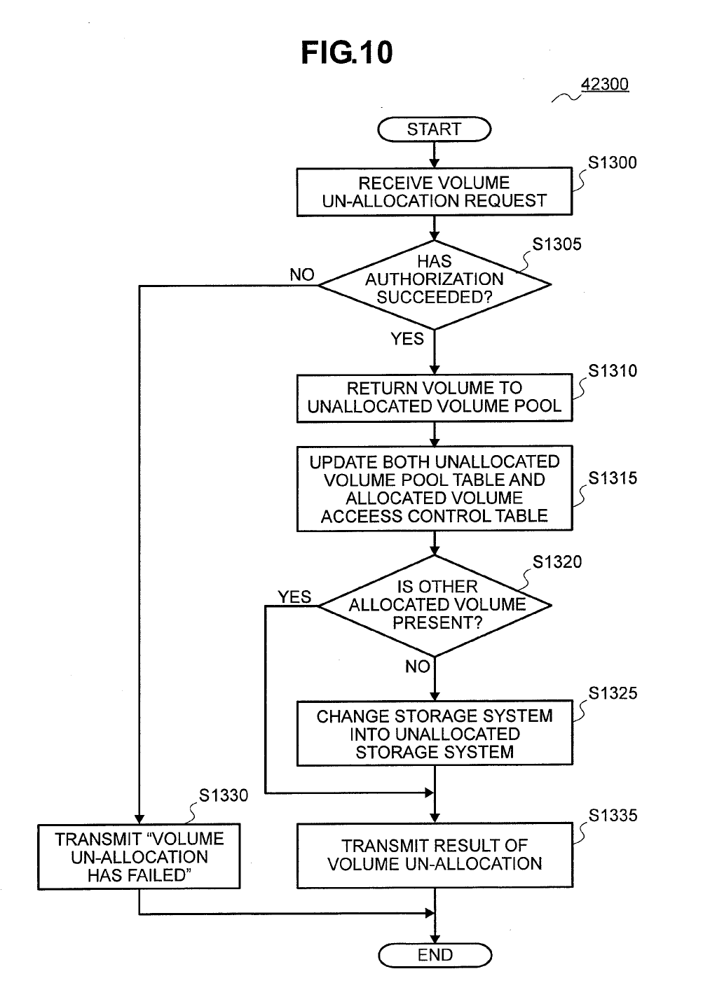

FIG. 10 is a flowchart describing the volume un-allocation program 42300. The general administrator 80000 uses the volume un-allocation program 42300 to cancel allocation of a volume 25000 to a host computer, that is, to un-allocate a volume 25000 allocated to a host computer, and to then return the volume to the unallocated volume pool 26000. The management computer 40000 runs the volume un-allocation program 42300. Within the volume un-allocation program, the management computer 40000 deprives the general administrator 80000, who has instructed un-allocation, of the authority to manage the logical configuration of the volume 25000 which is un-allocated. Moreover, if necessary, the management computer 40000 deprives the general administrator 80000 of the authority to manage the physical configuration of a storage system 20000 including the volume.

Prior to implementation of the control flow described in FIG. 10, the input/output program 42700 displays a login screen image like the one shown in FIG. 14D so as to acquire authorization information on the general administrator 80000 who requests un-allocation. Moreover, the input/output program 42700 prompts the general administrator to select a volume 25000 that is an object of un-allocation from the resource list display screen image 94000 shown in FIG. 14E. For example, check boxes 94020 are produced in association with respective entries for volumes in the volume list display field 94010. After a check is entered in any of the check boxes 94020, an Un-allocate Volume button 94040 is depressed. Consequently, the volume 25000 having the check entered in the associated check box 94020 is regarded as an object of un-allocation. The volume un-allocation program 42300 is then initiated.

First, the management computer 40000 receives a volume un-allocation request from the input/output program 42700 (step S1300). Specifically, the volume un-allocation request includes information on a general administrator who has instructed run of the volume un-allocation program 42300, which is retrieved from the login screen image 93000, and information on a volume 2500 that is an object of un-allocation which is retrieved from the resource list display screen image 94000.

After a volume un-allocation request is received, the management computer 40000 uses the information on the general administrator to verify whether the volume un-allocation request should be treated, that is, whether the general administrator is authorized (step S1305). Specifically, the management computer 40000 checks the general administrator information to see if it is consistent with the name of the general administrator 80000 and authorization information on the general administrator which are specified in the administrator table 43200. If the general administrator information is inconsistent, the processor 41000 transmits Volume Un-allocation Has Failed to the output unit 45000 (step S1330), and terminates the volume un-allocation program 42300.

Thereafter, the processor 41000 instructs the storage system 20000, which includes a volume 25000 that is an object of un-allocation, to delete the volume so that the volume 25000 that is an object of un-allocation will be returned to the unallocated volume pool 26000 (step S1310). Specifically, based on the information on a volume that is an object of un-allocation which is acquired at step S1300, that is, a volume ID of the volume that is an object of un-allocation and information on a storage system including the volume, the processor 41000 issues a volume deletion instruction, which includes as parameters the information on the general administrator who has instructed run of the volume un-allocation program 42300 and the volume ID of the volume that is an object of un-allocation, to the storage system 20000 including the volume that is an object of un-allocation. The storage system 20000 having received the volume deletion instruction runs the volume creation program 22400. Consequently, the entry for the volume that is an object of un-allocation is deleted from the allocated volume table 22100. The unallocated volume pool table 22200 is updated by adding the storage capacity of the volume that is an object of un-allocation to the total allocated storage capacity specified in the unallocated volume pool table 22200. A message saying that volume deletion has succeeded is returned to the management computer 40000. The processor 41000 included in the management computer 40000 receives the message, and the step S1310 is terminated.

Thereafter, since the un-allocated volume is deleted from the storage system 20000, the processor 41000 updates both the allocated volume access control table 43600 and the unallocated volume pool table 43500 (step S1315). Specifically, the processor 41000 searches the allocated volume access control table 43600 for the entry for the general administrator on the basis of the authorization information on the general administrator acquired at step S1300, and then deletes the entry for the un-allocated volume from the accessible volume list field 43620. Moreover, the processor 41000 searches the unallocated volume pool table 43500 for the entry for the storage system 20000 including the un-allocated volume, and updates the value specified in the total unallocated storage capacity field 43520 by adding the value of the storage capacity of the volume that is an object of un-allocation to the specified value.

Thereafter, the processor 41000 verifies whether the storage system 20000 having requested volume deletion at step S1310 includes other allocated volume 25000 (step S1320). Specifically, the processor 41000 checks the allocated volume table 22100 to see if it has the entry for the system ID of the storage system. If the storage system includes other allocated volume, control is jumped to step S1335. If the storage system does not include any other allocated volume, control is jumped to step S1325.

If the storage system 20000 is recognized at step S1320 that it does not have any other allocated volume, the processor 41000 changes the storage system 20000 into an unallocated storage system (step S1325). Specifically, the processor 41000 searches the allocated storage system access control table 43400 for the entry for the general administrator, and deletes information on the storage system from the accessible storage system list field 43420. Moreover, the entry for the storage system is appended to the unallocated storage system table 43300. Furthermore, the information on the supervisory administrator 80000 is used to issue an instruction saying that the entry for the general administrator who has instructed run of the volume un-allocation program 42200 should be deleted from the administrator table 22300 held in the storage system. Thus, the entry is deleted.

Finally, the processor 41000 transmits a result signifying a success in volume un-allocation to the output unit 45000 (step S1335), and terminates the program.

An example of a transmitted result is the resource list display screen image 94000 like the one shown in FIG. 14E in which the entry for a volume whose un-allocation is instructed is deleted from the volume list display area 94010. If the storage system including the volume whose un-allocation is instructed does not include an allocated volume, the entry for the storage system is deleted from the storage system list display area 94050. For display of information in the display areas, information specified in the allocated volume access control table 43600 updated at step S1310 and information specified in the allocated storage system access control table 43400 updated at step S1320 are transmitted.

The control flow to be implemented by the volume allocation program 42200 has been described so far.

If a plurality of volumes 25000 is selected as objects of un-allocation from the resource list display screen image 94000 prior to the implementation of the control flow described in FIG. 10, the volume allocation program 42200 is applied orderly to the selected volumes.

(2d) Access Control Changing Program 42400

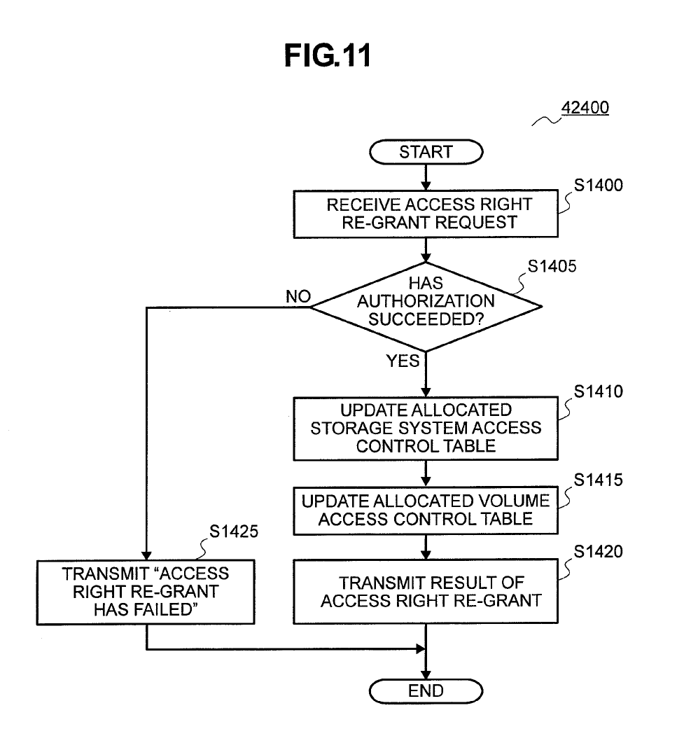

FIG. 11 is a flowchart describing the access control changing program 42400. The supervisory administrator 80000 uses the access control changing program 42400 to re-grant the authority to manage a configuration, which has been given to a certain general administrator, to any other general administrator. The management computer 40000 runs the access control changing program 42400. Within the program, the processor 41000 included in the management computer 40000 deprives the general administrator 80000 of all the authorities to manage the configurations of volumes and storage systems. The authorities to manage the configurations of the same volumes and storage systems are given to a new general administrator 80000.

Prior to the implementation of the control flow described in FIG. 11, the input/output program 42700 displays the login screen image 93000 like the one shown in FIG. 14D so as to acquire authorization information on the supervisory administrator 80000. Moreover, the input/output program 42700 displays an access right re-grant screen image 92000 shown in FIG. 14C so as to prompt entry of a previous administrator name 92010 and a new administrator name 92020. When the supervisory administrator 80000 depresses a Re-grant button 92030 with the previous administrator name 92010 and new administrator name 92020 entered, the access control changing program 42400 is initiated.

First, the processor 41000 included in the management computer 40000 receives an access right re-grant request from the input/output program 42700 (step S1400). Specifically, the access right re-grant request the processor 41000 receives includes information on a supervisory administrator who has instructed run of the access control changing program 42400, which is acquired from the login screen image 93000, and pieces of information on the previous administrator name 92010 and new administrator name 92020 which are acquired from the access right re-grant screen image 92000.

After receiving the access right re-grant request, the processor 41000 uses the information on the supervisory administrator to verify whether the access right re-grant request should be treated, that is, whether the supervisory administrator is authorized (step S1405). Specifically, the processor 41000 checks the supervisory administrator information to see if it is consistent with the name of a general administrator 80000 and authorization information on the general administrator which are specified in the administrator table 43200. If the supervisory administrator information is inconsistent, the processor 41000 transmit Access Right Re-grant Has Failed (step S1425), and terminates the access control changing program 42400.

Thereafter, the processor 41000 updates the allocated storage system access control table 43400 so as to re-grant the authority to manage the physical configuration of a storage system 20000 (step S1410). Specifically, the processor 41000 searches the allocated storage system access control table 43400 for the entry for the general administrator on the basis of the information on the previous general administrator name acquired at step S1400, and changes the administrator name specified in the entry into the new general administrator name. Furthermore, the information on the supervisory administrator 80000 is used to modify information specified in the entry for the general administrator in the administrator table 22300 held in the storage system.

Thereafter, the processor 41000 updates the allocated volume access control table 43600 so as to re-grant the authority to manage the logical configuration of an allocated volume 25000 (step S1415). Specifically, the processor 41000 searches the allocated volume access control table 43600 for the entry for the general administrator on the basis of the information on the previous general administrator name acquired at step S1400, and changes the administrator name specified in the entry into the new general administrator name.

Finally, the processor 41000 transmits a result of access right re-grant (step S1420), and terminates the access control changing program 42400.

The control flow to be implemented by the access control changing program 42400 has been described so far.

(2e) Administrator Deletion Program 42500 to be Run in Order to Delete Information on a General Administrator

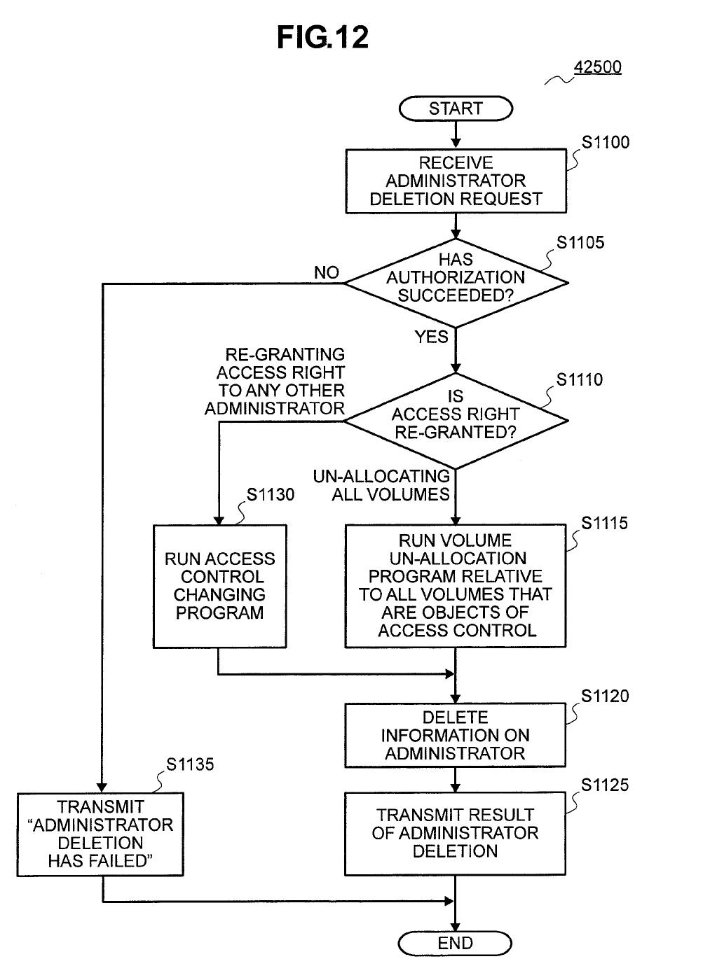

FIG. 12 is a flowchart describing the administrator deletion program 42500. The supervisory administrator 80000 uses the administrator deletion program 42500 to delete information on a certain general administrator, and the management computer 40000 runs the administrator deletion program 42500. Within the program, the management computer 40000 deprives the general administrator 80000, who is an instructed object of deletion, of all the authorities to manage the configurations of volumes and storage systems, or re-grants the authorities to any other administrator.

Prior to the implementation of the control flow described in FIG. 12, the input/output program 42700 displays the login screen image 93000 like the one shown in FIG. 14D so as to acquire authorization information on the supervisory administrator 80000. Moreover, the input/output program 42700 displays the administrator deletion screen image 91000 shown in FIG. 14B so as to prompt entry of an administrator name 91010 to be deleted and an access control method 91020 to be adopted after the administrator name is deleted. The access control method 91020 to be adopted after an administrator name is deleted falls into two methods, that is, a method in which all the authorities to manage configurations are re-granted to other general administrator responsively to deletion of one administrator name, and a method in which all allocated volumes are un-allocated. In the former case, the supervisory administrator 80000 is prompted to enter a new general administrator name 91030. The supervisory administrator 80000 selects either of the two access control methods, and depresses a Delete Administrator button 91040, whereby the administrator deletion program 42500 is initiated.

First, the processor 41000 included in the management computer 40000 receives an administrator deletion request from the input/output program 42700 (step S1100). Specifically, the administrator deletion request the processor 41000 receives includes information on a supervisory administrator who has instructed run of the administrator deletion program 4500 which is acquired from the login screen image 93000 and pieces of information on the administrator name 91010 to be deleted and the access control method 91020 to be adopted after an administrator name is deleted which are acquired from the administrator deletion screen image 91000.

After receiving the administrator deletion request, the processor 41000 uses the information on the supervisory administrator to verify whether the administrator deletion request should be treated, that is, whether the supervisory administrator is authorized (step S1105). Specifically, the processor 41000 checks the supervisory administrator information to see if it is consistent with the mane of the general administrator 80000 and authorization information on the general administrator which are specified in the administrator table 43200. If the supervisory administrator information is inconsistent, the processor 41000 transmits Administrator Deletion Has Failed (step S1135), and terminates the administrator deletion program 42500.

If authorization succeeds at step S1105, the processor 41000 determines an access control method (step S1110). Specifically, the processor 41000 determines the access control method on the basis of the access control method 91020 to be adopted after completion of administrator deletion which is acquired at step S1105. If an access right is re-granted to any other administrator, control is jumped to step S1130. If all allocated volumes are un-allocated, control is jumped to step S1115.

If an access right is re-granted to any other administrator at step S1110, the processor 41000 runs the access control changing program 42400 using the administrator name 91010 to be deleted and a new administrator name specified in the access control method 91020 to be adopted after completion of administrator deletion (step S1130). The access control changing program 42400 has already been described, and the reiterative description thereof will be omitted. Thereafter, control is jumped to step S1120.

If all allocated volumes are un-allocated at step S1115, the processor 41000 runs the volume un-allocation program 42300 relative to all the allocated volumes having access rights therefor granted to the general administrator who is an object of deletion (step S1115). The volume un-allocation program 42300 has already been described, and the iterative description thereof will be omitted. Thereafter, control is jumped to step S1120.

Thereafter, the processor 41000 deletes information on the general administrator who is an object of deletion (step S1120). Specifically, based on the administrator name 91010 to be deleted which is acquired at step S1100, the entry for the general administrator who is an object of deletion is deleted from the administrator table 43200.

Finally, the processor 41000 transmits a result of administrator deletion (step S1125), and terminates the administrator deletion program 42500.

The control flow to be implemented by the administrator deletion program 42500 has been described so far.

### (3) Concrete Volume Allocation Execution Process Employed in the First Embodiment

Next, a concrete volume allocation execution process to be achieved by running the programs described in relation to the first embodiment will be described using FIG. 13A, FIG. 13B, FIG. 13C, FIG. 13D, and FIG. 13E in that order. The execution process is as follows:

(3a) the entries for the general administrators ADM1 and ADM2 are created; (3b) the general administrator ADM1 allocates a volume having a storage capacity of 100 G bytes to the host computer H1; (3c) the general administrator ADM2 allocates a volume having a storage capacity of 400 G bytes to the host computer H2; (3d) the general administrator ADM2 allocates a volume having a storage capacity of 200 G bytes to the host computer H2; and (3e) the general administrator ADM2 un-allocates the 400-gigabyte volume allocated to the host computer H2.

The stages (3a) to (3e) will be described below.

(3a) Creating the Entries for the General Administrators ADM1 and ADM2

FIG. 13A shows examples of the unallocated storage system table 43300, allocated storage system access control table 43400, unallocated volume pool table 43500, and allocated volume access control table 43600 that are stored in the memory 42000 included in the management computer 40000, and thus shows the results of run of the administrator creation program 42100.

When the supervisory administrator 80000 enters data in the administrator creation screen image 90000, the management computer 40000 runs the administrator creation program 42100. Consequently, the entries for the general administrators ADM1 and ADM2 are newly created in the allocated storage system access control table 43400 and allocated volume access control table 43600. FIG. 13A shows the results.

(3b) The General Administrator ADM1 Allocates a 100-Gigabyte Volume to the Host Computer H1.

FIG. 13B shows examples of the unallocated storage system table 43300, allocated storage system access control table 43400, unallocated volume pool table 43500, and allocated volume access control table 43600 which are stored in the memory 42000 included in the management computer 40000, and thus shows the results of run of the volume allocation program 42200.

Specifically, first, the general administrator ADM1 enters data in the volume allocation screen image 95000 with the tables held in the states shown in FIG. 13A. Consequently, allocation of a volume having a storage capacity of 100 G bytes to the host computer H1 is instructed, and the management computer 40000 runs the volume allocation program 42200.

At step S1215, the management computer 40000 recognizes that an accessible storage system is not specified in the entry for the administrator ADM1 in the allocated storage system access control table 43400.

At step S1225, the management computer 4000 extracts the storage systems ST2, ST3, and ST4, which are specified in the entry in the unallocated storage system table 43300, as candidates for volume creation.

A description will proceed on the assumption that the storage system ST2 is selected at step S1240.

At step S1245, the management computer 40000 issues a volume creation request to the storage system ST2.

At step S1250, the management computer 40000 subtracts 100 gigabytes from the total unallocated storage capacity of the storage system ST2 specified in the unallocated volume table 43500. At step S1255, the management computer 40000 registers a volume v1 included in the storage system ST2 in the entry for the general administrator ADM1 in the allocated volume access control table 43600. At step S1265, the storage system ST2 is appended to the entry for the general administrator ADM1 in the allocated storage system access control table 43400, and the entry for the storage system ST2 is deleted from the unallocated storage system table 43300.

FIG. 13B shows the results of the foregoing sequence.

(3c) The General Administrator ADM2 Allocates a 400-Gigabyte Volume to the Host Computer H2.

FIG. 13C shows examples of the unallocated storage system table 43300, allocated storage system access control table 43400, unallocated volume pool table 43500, and allocated volume access control table 43600 which are stored in the memory 42000 included in the management computer 40000, and thus shows the results of run of the volume allocation program 42200 under the circumstances of allocation shown in FIG. 13B.

When the general administrator ADM2 enters data in the volume allocation screen image 95000 with the tables in the states shown in FIG. 13B, allocation of a volume having a storage capacity of 400 G bytes to the host computer H2 is instructed. The management computer 40000 runs the volume allocation program 42200.

Specifically, first, at step S1215, the management computer 4000 recognizes that an accessible storage system is not specified in the entry for the administrator ADM2 in the allocated storage system access control table 43400. At step S1225, the management computer 4000 extracts as candidates for volume creation the storage systems ST3 and ST4 that are specified in the unallocated storage system table 43300. As for the storage system ST2, the authority to manage the configuration thereof has already been given to the general administrator ADM1 in the stage 3(b), and the storage system ST2 is not specified in the unallocated storage system table 43300. Therefore, the storage system ST2 is not recognized as a candidate for volume creation.

Assume that the storage system ST3 has been selected at step S1240. The management computer 4000 issues a volume creation request to the storage system ST3 at step S1240. Thereafter, the management computer 4000 subtracts 400 G bytes from the total unallocated storage capacity of the storage system ST3 specified in the unallocated volume table 43500. The management computer 40000 registers a volume v2, which is included in the storage system ST3, in the entry for the general administrator ADM2 in the allocated volume access control table 43600.

Finally, at step S1265, the management computer 40000 appends the storage system ST3 to the entry for the general administrator ADM2 in the allocated storage system access control table 43400, and deletes the entry for the storage system ST3 from the unallocated storage system table 43300.

FIG. 13C shows the results of the foregoing sequence.

(3d) The General Administrator ADM2 Allocates a 200-Gigabyte Volume to the Host Computer H2.

FIG. 13D shows examples of the unallocated storage system table 43300, allocated storage system access control table 43400, unallocated volume pool table 43500, and allocated volume access control table 43600 which are stored in the memory 4200 included in the management computer 40000, and thus shows the result of run of the volume allocation program 42200 under the circumstances of allocation shown in FIG. 13C.

When the general administrator ADM2 enters data in the volume allocation screen image 95000 with the tables held in the states shown in FIG. 13C, allocation of a volume having a storage capacity of 200 G bytes to the host computer H2 is instructed. The management computer 40000 runs the volume allocation program 42200.

At step S1215, the storage system ST3 is specified in the entry for the administrator ADM2 in the accessible storage system list field in the storage system access control table 43400.

At step S1220, the management computer 40000 recognizes that the unallocated storage capacity specified in the entry for the storage system ST3 in the unallocated volume table 43500 is 100 G bytes and that a volume having a storage capacity of 200 G bytes cannot be allocated from the storage system ST3. Eventually, a candidate for volume creation is not extracted.

At step S1225, the management computer 4000 extracts the storage system ST4, which is specified in the unallocated storage system table 43300, as a candidate for volume creation.

Thereafter, at step S1240, the storage system ST4 is selected. In this case, the management computer 40000 issues a volume creation request to the storage system ST4 at step S1245. Thereafter, at step S1250, the management computer 40000 subtracts 200 G bytes from the total unallocated storage capacity of the storage system ST4 specified in the unallocated volume table 43500. At step S1255, the management computer 40000 registers a volume v3, which is included in the storage system 4, in the entry for the general administrator ADM2 in the allocated volume access control table 43600. Finally, at step S1265, the management computer 40000 appends the storage system ST4 to the entry for the general administrator ADM2 in the allocated storage system access control table 43400, and deletes the entry for the storage system ST4 from the unallocated storage system table 43300.

FIG. 13D shows the results of the foregoing sequence.

(3e) The General Administrator ADM2 Un-Allocates a 400-Gigabyte Volume Allocated to the Host Computer H2.

FIG. 13E shows examples of the unallocated storage system table 43300, allocated storage system access control table 43400, unallocated volume pool table 43500, and allocated volume access control table 43600 which are stored in the memory 42000 included in the management computer 40000, and thus shows the results of run of the volume un-allocation program 42300 under the circumstances of allocation shown in FIG. 13D.

When the general administrator ADM2 enters data in the resource list display screen image 94000 with the tables held in the states shown in FIG. 13D, un-allocation of a 400-gigabyte volume allocated to the host computer H2 is instructed. The management computer 4000 runs the volume un-allocation program 42300.

At step S1310, the management computer 4000 issues a volume v2 deletion instruction to the storage system ST3. At step S1315, the management computer 4000 adds a storage capacity of 400 G bytes, which is offered by the volume v2, to the storage capacity specified in the entry for the storage system ST3 in the unallocated volume table 43500. Moreover, the management computer 40000 deletes the entry for a volume v3 from the entry for the administrator ADM2 in the allocated volume access control table 43600. At step S1320, the management computer 40000 recognizes that the storage system ST3 does not include any other allocated volume.

Finally, the management computer 40000 deletes the information on the storage system ST3 from the entry for the general administrator ADM2 in the allocated storage system access control table 43400 at step S1325. Furthermore, the management computer 40000 appends the information on the storage system ST3 to the unallocated storage system table 43300.

FIG. 13E shows the results of the foregoing sequence.

As seen from the aforesaid concrete volume allocation execution process, according to the present invention, each of general storage administrators will not be affected by a manipulation any other general storage administrator performs in order to modify a configuration. Consequently, the storage administrator can safely manage the configuration of a storage system. Moreover, the storage systems used by the respective general storage administrators are different from one another. Stoppage of a storage system caused by scheduled maintenance will not affect other jobs. This leads to improved availability of an entire computer system.

### Second Embodiment

According to the first embodiment, in a computer system including a plurality of storage systems, the authority to manage the physical configuration of a storage system is re-granted responsively to volume allocation or un-allocation. Management of configurations of storage systems can be controlled under a management organization in which a plurality of storage administrators manages the computer system.

In relation to the second embodiment, a description will be made of management of configurations of storage systems in consideration of a volume virtualization environment. Prior to description of the second embodiment, a volume virtualization facility will be described. The volume virtualization environment is based on an art for alleviating a load an administrator incurs for volume allocation, for example, an art disclosed in GB Patent Publication No. 2351375 (Patent Document 3). According to Patent Document 3, equipment called a storage server has three functions: (1) a function for detecting volumes included in storage systems and managing the volumes in the form of an unallocated volume pool included in the storage server itself; (2) a function for creating a virtual volume in a storage server on the basis of one or more volumes included in an unallocated volume pool and allocating the virtual volume to a host computer; and (3) a function for, when a host computer accesses data contained in a virtual volume, transforming the virtual volume into an address of an actual volume and thus relaying data access so as to enable data access from the host computer. When the equipment including the volume virtualization facility is employed, a user of a host computer or a general storage administrator should merely allocate a volume while being conscious of the equipment including the volume virtualization facility. Thus, the load the administrator must incur for allocation of a volume is alleviated.

### (1) Configuration of a Computer System in Accordance with the Second Embodiment

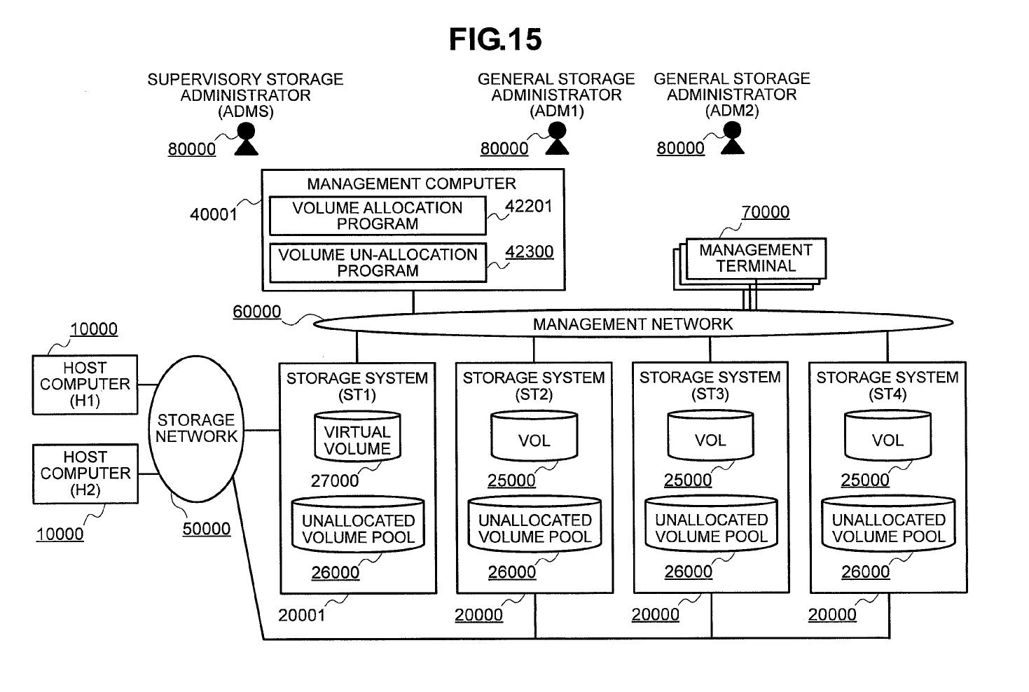

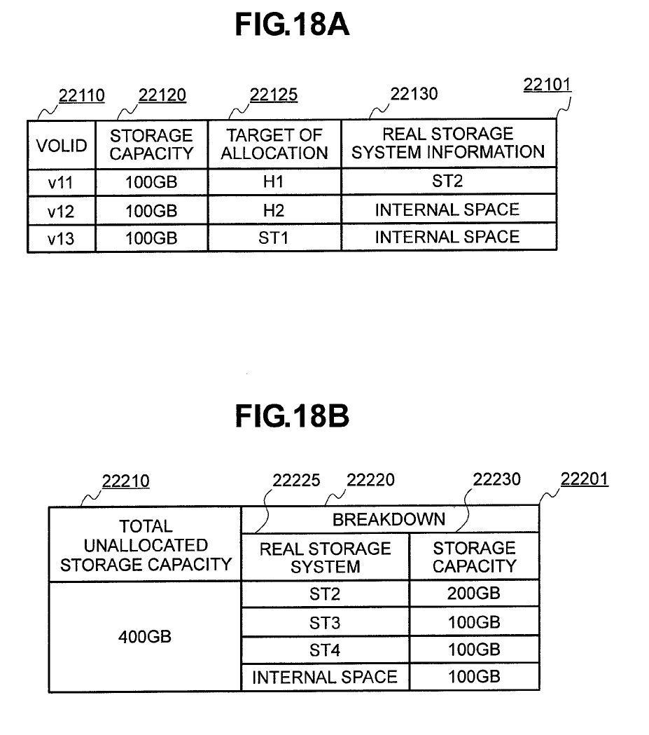

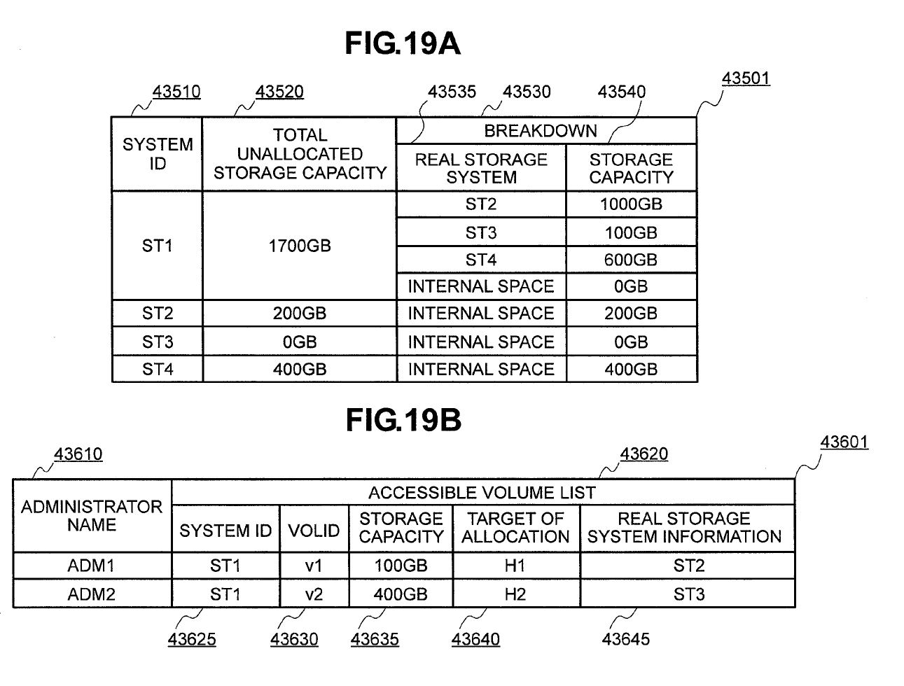

The configuration of a computer system in accordance with the second embodiment will be described below. FIG. 15 to FIG. 17 show the configuration of the computer system and the configurations of pieces of equipment connected to the computer system. FIG. 18 and FIG. 19 show pieces of management information preserved in the pieces of equipment.

FIG. 15 shows the configuration of the computer system in accordance with the second embodiment. Only differences from the first embodiment will be described below. According to the second embodiment, a storage system 20001 (whose system ID is ST1) has the volume virtualization facility. Allocation of a volume to host computers H1 and H2 is performed as allocation of a virtual volume included in the storage system ST1. Moreover, a management computer 40001 has a volume allocation program 42201 installed therein. The other components are identical to those of the first embodiment.

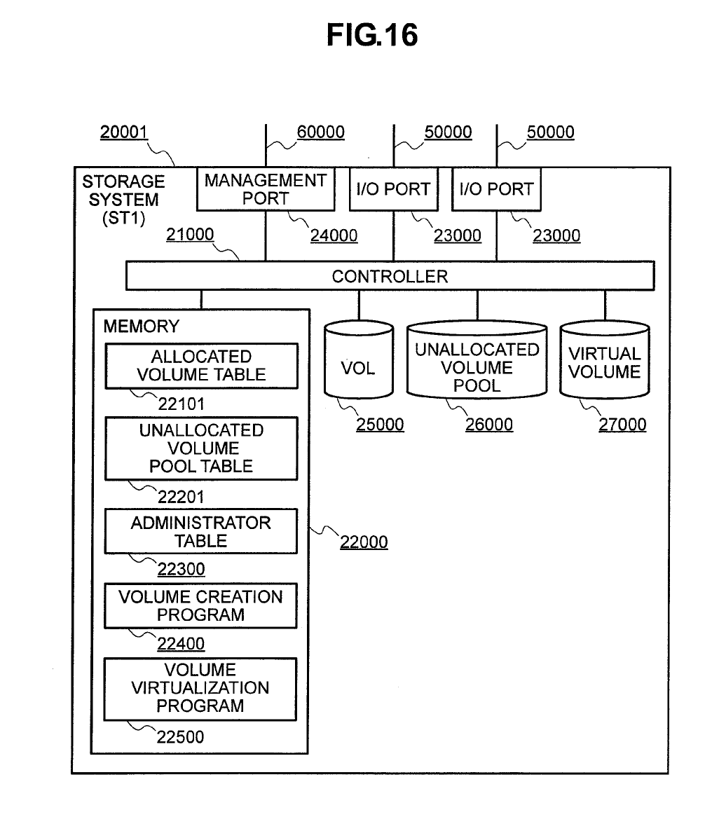

FIG. 16 shows the detailed configuration of the storage system 20001 having the volume virtualization facility and being included in the second embodiment. Differences of the configuration of the storage system 20001 having the volume virtualization facility from the configuration of the storage system 20000 are that the storage system 20001 has a virtual volume 27000, that the structure of an allocated volume table 22101 stored in the memory 22000 is different, that the structure of an unallocated volume pool table 22201 is different, and that a volume virtualization program 22500 is installed.

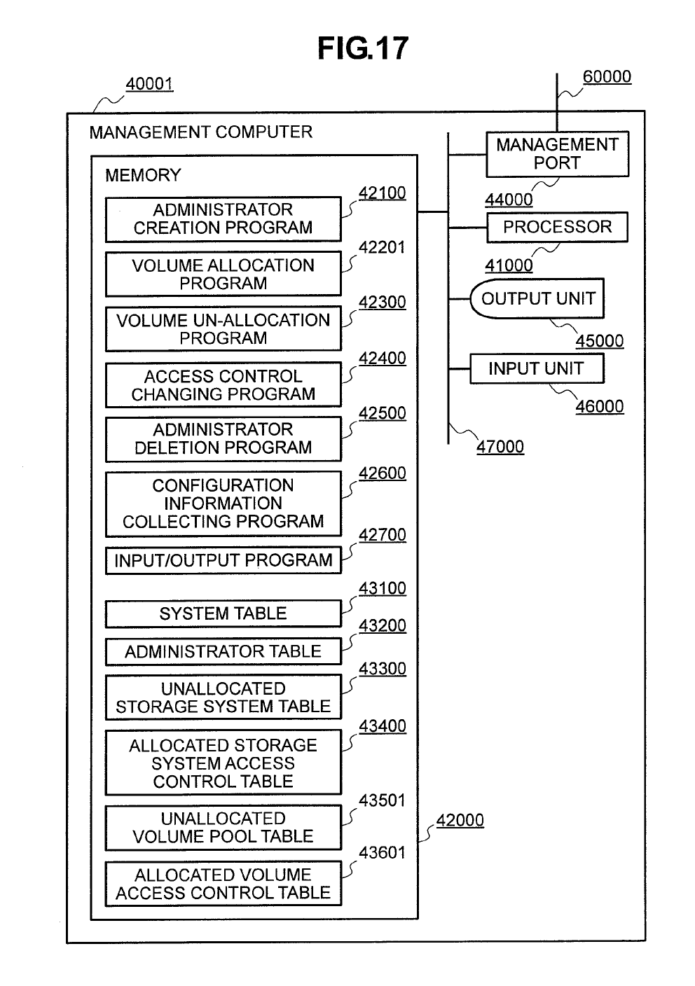

FIG. 17 shows the detailed configuration of the management computer 40001 included in the second embodiment. Differences of the configuration of the management computer 40001 from the configuration of the management computer 40000 included in the first embodiment are that the volume allocation program 42201 is different, that the structure of the unallocated volume pool table 43501 is different, and that the structure of the allocated volume access control table 43601 is different.

FIG. 18A and FIG. 18B show examples of tables preserved in the storage system 20001 having the volume virtualization facility and being included in the second embodiment.

FIG. 18A shows an example of an allocated volume table 22101 for use in managing the virtual volume 27000 included in the storage system 20001 having the volume virtualization facility. The allocated volume management table 22101 has, in addition to a volume ID field 22110, a storage capacity field 22120, and a target-of-allocation field 22125 that are identical to the counterparts included in the allocated volume management table 22100 employed in the first embodiment, a real storage system information field 22130 in which information on a volume realizing a virtual volume is specified.

FIG. 18B shows an example of an unallocated volume pool table 22201 for use in managing an unallocated volume pool 26000 preserved in the storage system 20001 having the volume virtualization facility. The unallocated volume pool table 22201 has, in addition to a total unallocated storage capacity field 22210 identical to the counterpart included in the unallocated volume pool table 22200 employed in the first embodiment, a field 22220 in which the breakdown of a total unallocated storage capacity is specified. The field 22220 in which the breakdown of a total unallocated storage capacity is specified comprises a real storage system field 22225 in which a storage system 20000 providing the storage system 20001, which has the volume virtualization facility, with volume is specified, and a storage capacity field 22230 in which the storage capacity offered by the volume provided by the storage system 20000 is specified.

FIG. 19A and FIG. 19B show examples of tables preserved in the management computer 40001 included in the second embodiment.

FIG. 19A shows an example of an unallocated volume pool table 43501 which the management computer 40001 uses to manage the unallocated volume pool 26000. The unallocated volume pool table 43501 has, in addition to a system ID field 43510 and a total unallocated storage capacity field 43520 identical to the counterparts included in the unallocated volume pool table 43500 employed in the first embodiment, a field 43530 in which the breakdown of a total unallocated storage capacity is specified. The field 43530 in which the breakdown of a total unallocated storage capacity is specified falls into a real storage system field 43535 in which a storage system 20000 providing a storage system having an associated system ID with volume in which data to be used by a host computer is stored is specified, and a storage capacity field 43540 in which a storage capacity offered by the volume provided by the associated storage system 20000 is specified. In relation to the storage system 20001 having the volume virtualization facility, the same pieces of information as those specified in the fields included in the unallocated volume pool table 22201 are specified in the fields 43535 and 43540. In relation to the other storage systems 20000, the internal spaces of the storage systems are specified in the breakdown field 43530.

FIG. 19B shows an example of an allocated volume access control table 43601 for use in managing a virtual volume 27000 allocated to a host computer 10000. The allocated volume access control table 43601 has an administrator name field 43610 and an accessible volume list field 43620 identical to the counterparts included in the allocated volume access control table 43600 employed in the first embodiment. The accessible volume list field further includes a real storage system information field 43645 in which information on a volume realizing a virtual volume is specified. The virtual volume is realized with volume which the host computer 10000 can mount or identify. Data the host computer actually uses is stored in the real volume included in a storage system specified in the real storage system information field. Thus, the virtual volume is virtual disk space provided for the host computer 10000. Moreover, real volume realizing one virtual volume may be one real volume or a plurality of real volumes that may be included in a plurality of storage systems.

### (2) Control Flows to be Implemented by Programs Employed in the Second Embodiment

All of the programs described in relation to the first embodiment except the volume allocation program 42200 are also employed in the second embodiment. The iterative description of the programs will be omitted.

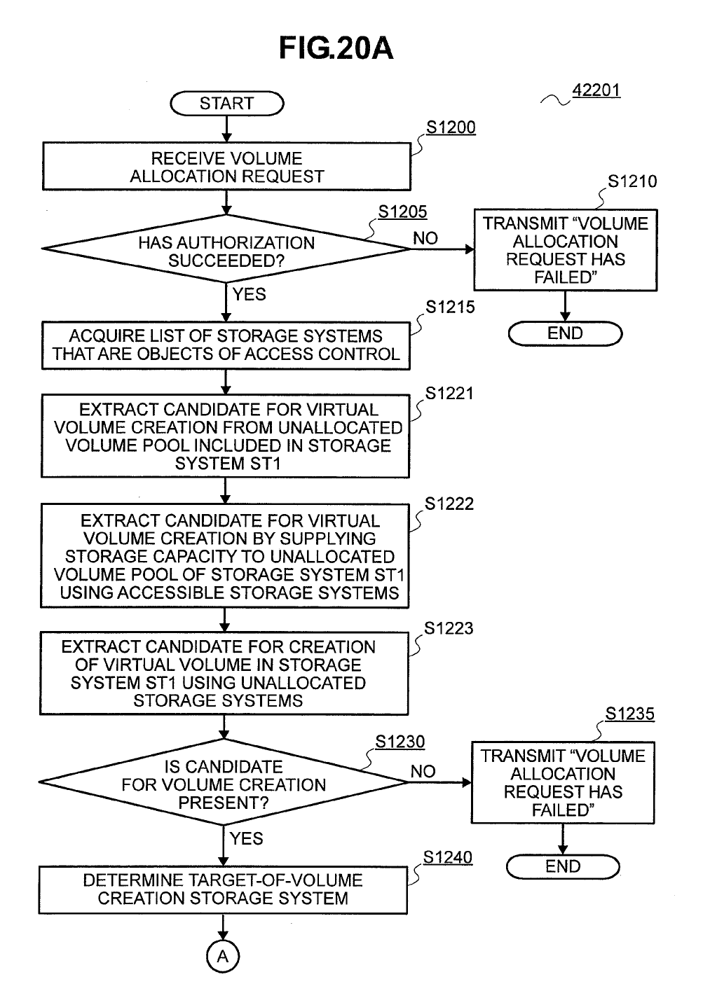

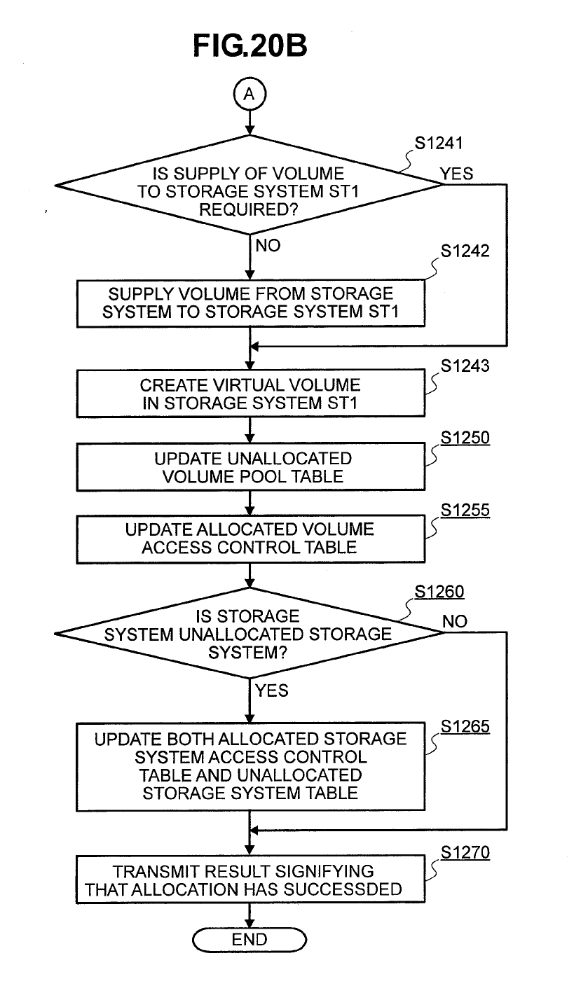

FIG. 20A and FIG. 20B are flowcharts describing a volume allocation program 42201. As for the volume allocation program 42200, the general administrator 80000 uses it to allocate the virtual volume 27000 to a host computer and the management computer 40000 runs it. Within the program, the management computer 40000 gives the general administrator 80000, who has instructed allocation, the authority to manage the logical configuration of the virtual volume 27000 to be allocated and the authority to manage the physical configuration of a storage system 20000 including a volume that realizes the virtual volume.

The input/output program 42700 displays a screen image before the control flow described in FIG. 20A and FIG. 20B is implemented in the same manner as it does before the control flow is implemented by the volume allocation program 42200 employed in the first embodiment. The iterative description thereof will be omitted.

Furthermore, step S1200 of receiving a volume allocation request, authorization step S1205, step S1210 of transmitting Volume Allocation Request Has Failed, and step S1215 of acquiring a list of storage systems that are objects of access control are identical to the counterparts included in the volume allocation program 42200 employed in the first embodiment. The iterative description thereof will be omitted.

A step of extracting a candidate for volume creation is different from the one included in the first embodiment, and will therefore be described below.

If authorization succeeds at step S1205, the processor 41000 included in the management computer 40000 verifies whether a virtual volume can be created from an unallocated volume pool included in the storage system ST1 (step S1221). Specifically, the processor 41000 extracts the entry for the storage system ST1 from the unallocated volume pool table 43501, and checks an unallocated storage capacity of a real storage system, which is a storage system accessible to a general administrator who has requested allocation, to see if it is equal to or larger than the value of an allocated volume storage capacity 95020. If the unallocated storage capacity is equal to or larger than the allocated volume storage capacity 95020, the processor 41000 recognizes that the storage system can be allocated, and extracts the storage system ST1 as a candidate for volume creation. Unlike the first embodiment, in the second embodiment, a plurality of storage systems 20000 may be selected as real storage systems and combined to create one virtual volume.

Thereafter, the processor 41000 uses a storage system accessible to the general administrator, who has requested allocation, to supply a storage capacity to the unallocated volume pool included in the storage system ST1, and extracts a candidate for virtual volume creation (step S1222). Specifically, the processor 41000 extracts storage systems accessible to the general administrator, who has requested allocation, from the unallocated volume pool table 43501. If the sum total of the total unallocated storage capacities of the storage systems is equal to or larger than the value of the allocated volume storage capacity 95020, the storage systems are recognized to be able to be allocated. The storage systems are extracted as a candidate for volume creation. Unlike the first embodiment, in the second embodiment, a plurality of storage systems 20000 may be selected and combined as a candidate for virtual volume creation.

Thereafter, the processor 41000 uses unallocated storage systems to extract a candidate for creation of a virtual volume in the storage system ST1 (step S1223). Specifically, the processor 41000 extracts the entry for the storage system ST1 from the unallocated volume pool table 43501, and checks the sum total of the total unallocated storage capacities of real storage systems that are unallocated storage systems to see if it is equal to or larger than the value of the allocated volume storage capacity 95020. If the sum total of the total unallocated storage capacities is equal to or larger than the allocated volume storage capacity 95020, the storage systems are recognized to be able to be allocated. The storage systems are extracted as a candidate for volume creation. If the sum total of storage capacities which the unallocated storage systems have not offered as disk spaces to the storage system ST1, that is, the sum total of total unallocated storage capacities specified in the entries for the unallocated storage systems in the unallocated volume pool table 43501 is equal to or larger than the value of the allocated volume storage capacity 95020, the storage systems are recognized to be able to be allocated and extracted as a candidate for volume creation. Unlike the first embodiment, in the second embodiment, a plurality of storage systems 20000 may be selected and combined as a candidate for virtual volume creation.

Step S1230 of verifying whether a candidate for volume creation is present, step S1235 of transmitting Volume Allocation Request Has Failed, and step S1240 of determining a target-of-volume creation storage system which succeed the step S1223 are identical to the counterparts included in the volume allocation program 42200 employed in the first embodiment. The iterative description thereof will therefore be omitted.

After the completion of step S1240, the processor 41000 verifies whether a storage system selected as a target of volume creation should provide the storage system ST1 with a volume (step S1241). Specifically, if the storage system selected as the target of volume creation is managed as a storage system whose volume is included in an unallocated volume pool of the storage system ST1, the processor 41000 recognizes that provision of a volume is not required, and then jumps control to step S1243. Otherwise, provision of a volume is recognized to be required, and control is jumped to step S1242.

If provision of a volume is recognized to be required at step S1241, the processor 41000 supplies a volume included in the storage system, which is selected as the target of volume creation, to the unallocated volume pool of the storage system ST1 (step S1242). Specifically, first, the processor 41000 creates a volume in the storage system selected as the target of volume creation. Thereafter, the processor 41000 runs the volume virtualization program 22500 residing in the storage system ST1 so as to instruct the storage system ST1 via a management port 44000 so that the storage system ST1 should include the volume, which is created in the storage system selected as the target of volume creation, in the unallocated volume pool. Owing to this step, a volume included in the storage system selected as the target of volume creation can be provided as a virtual volume.

If the storage system selected as the target of volume creation is recognized to be managed as a storage system, of which volume is included in the unallocated volume pool of the storage system ST1, at step S1241, or after the completion of step S1242, the processor 41000 instructs the storage system ST1 to create a virtual volume (step S1243).

Unallocated volume pool table updating step S1250, allocated volume access control table updating step S1255, step S1260 of verifying whether a storage system is an unallocated storage system, step S1265 of updating both the allocated storage system access control table and unallocated storage system table in case a storage system is an unallocated storage system, and step S1270 of transmitting a result signifying that allocation has succeeded, which succeed step S1243, are identical to the counterparts included in the volume allocation program 42200 employed in the first embodiment. The iterative description of the steps will therefore be omitted.

The control flow to be implemented by the volume allocation program 42201 has been described so far.

Owing to the foregoing volume allocation program 42201, even when a computer system includes a storage system that has a volume virtualization facility, each of general storage administrators will not be affected by a manipulation performed by any other general storage administrator in order to modify a configuration. The storage administrator can therefore safely manage the configuration of a storage system. Furthermore, storage systems to be used by the respective general storage administrators are different from one another. Stoppage of a storage system caused by scheduled maintenance or the like will not affect any other job. This leads to improved availability of the entire computer system. Furthermore, according to the second embodiment that has an advantage over the first embodiment, the volume allocation program 42201 uses the volume virtualization facility to allocate a volume by making the most of disk space included in a storage system.

When a computer system is brought to a volume virtualization environment to which the present embodiment is adapted, a load an administrator must incur for allocation of a volume is alleviated. To whichever of administrators the authority to manage a physical configuration or to create a volume is given can be controlled.

### (3) Variant of Second Embodiment

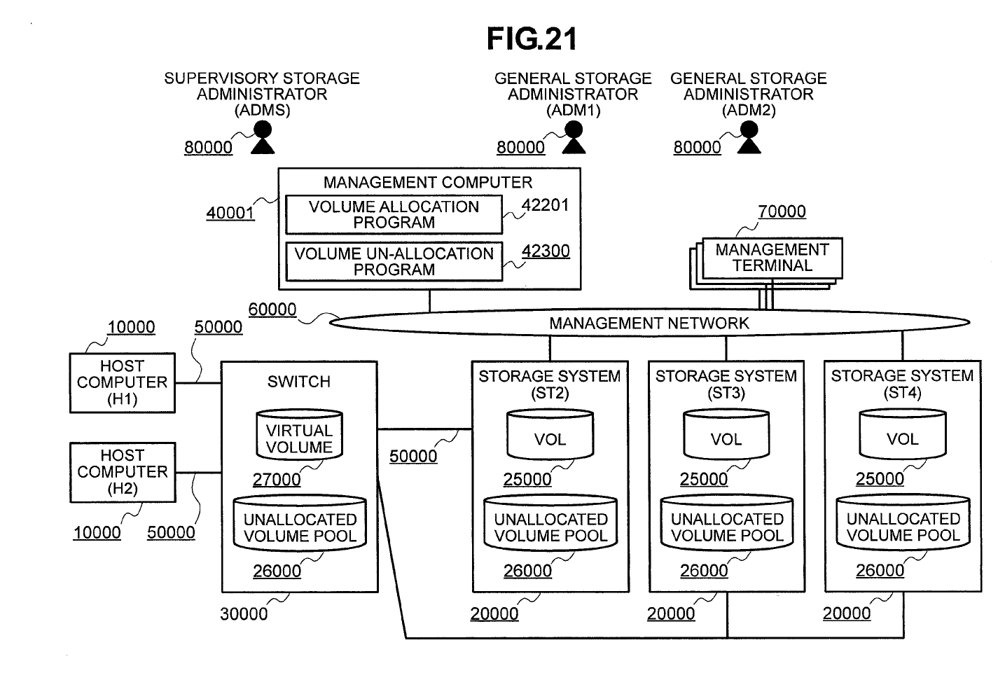

A storage system does not always have the volume virtualization facility. A variant of the second embodiment is shown in FIG. 21. A difference of FIG. 21 from FIG. 15 lies in a point that the storage system ST1 is not provided with the volume virtualization facility but a switch 30000 accommodated in the storage network 5000 is provided therewith.

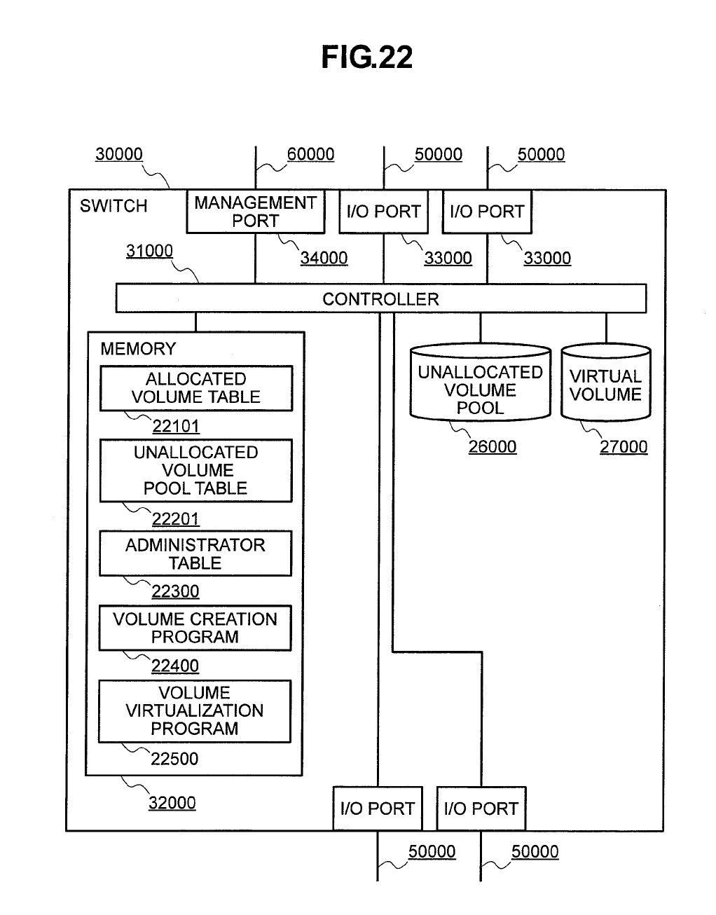

FIG. 22 shows an example of the detailed configuration of the switch 30000 having the volume virtualization facility. The switch 30000 comprises a controller 31000 that controls the switch, a memory 32000, one or more I/O ports 33000 via which the switch 30000 is connected on the storage network 50000, and a management port 34000 via which the switch 30000 is connected on the management network 60000. These components are interconnected via the controller 31000. An allocated volume table 22101, an unallocated volume pool table 22201, an administrator table 22300, a volume creation program 22400, and a volume virtualization program 22500 are stored in the memory 32000. The tables and programs are loaded from a hard disk or any other storage medium (not shown) into the memory 32000, and the programs are then run.

Moreover, a switch control program is loaded from the storage medium into the memory 32000, though the switch control program is not shown. When the controller 31000 runs the program, a data path on a data network is controlled.

Even in the variant, the management computer 40001 permits each of general storage administrators to manage a configuration while being unaffected by a manipulation any other general storage administrator performs for modifying a configuration.

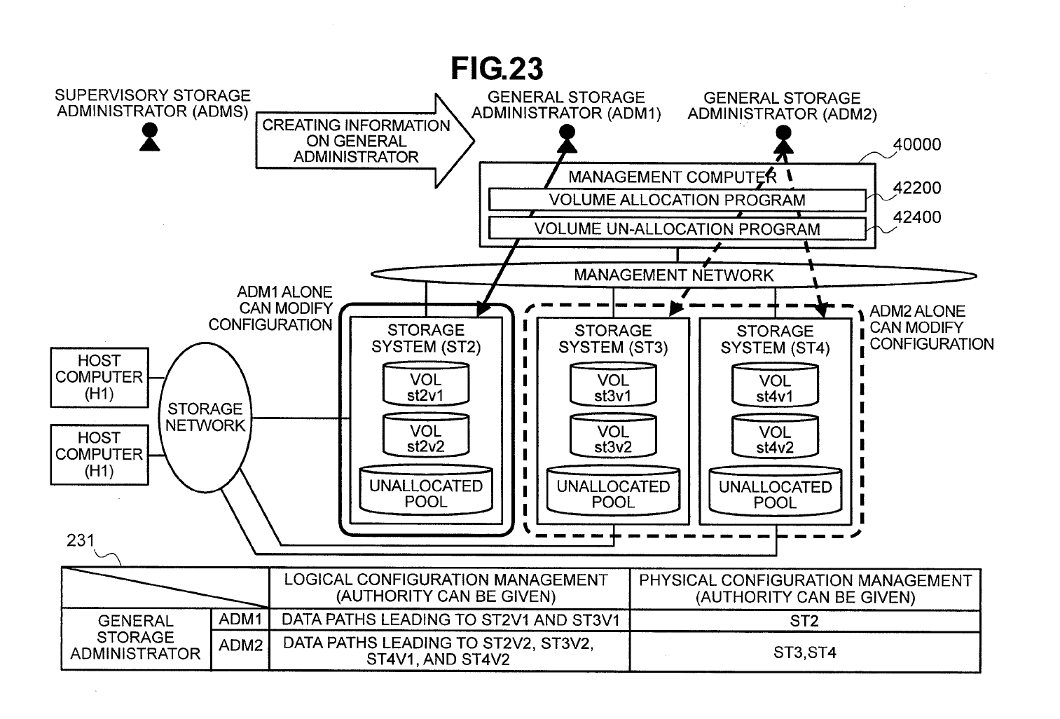

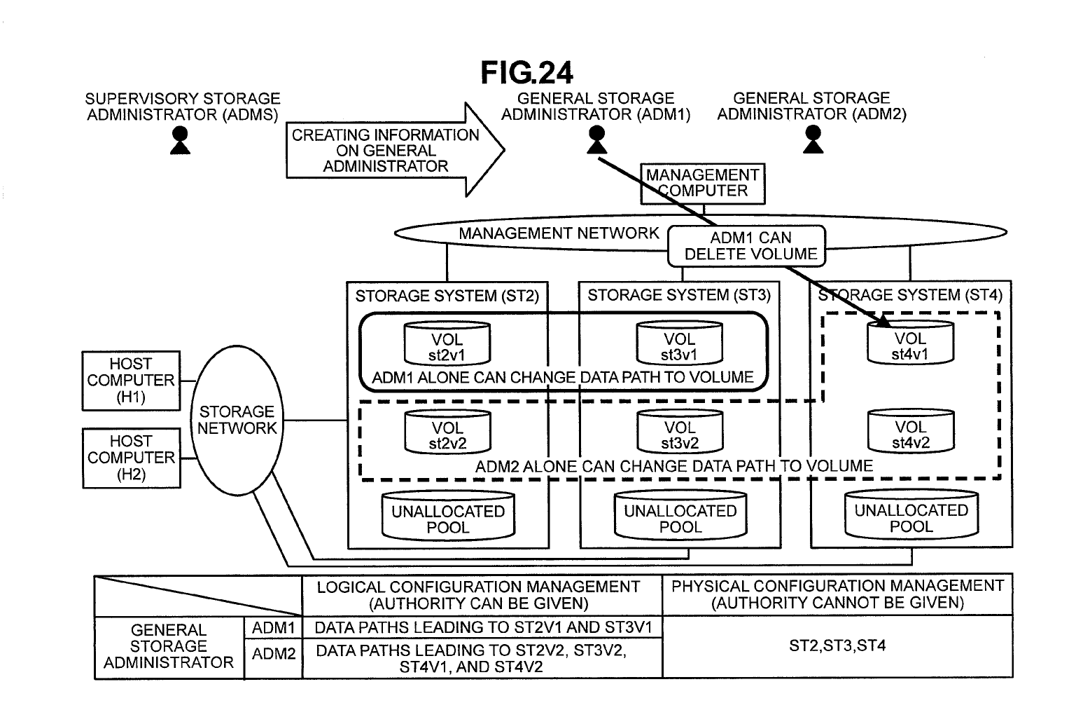

Various embodiments have been described so far. A working mode will be outlined in conjunction with FIG. 23.

In the working mode, a volume allocation program 42200 installed in a management computer 40000 gives a storage administrator the authority to manage the physical configuration of a storage system, which includes a created volume, responsively to the creation of the volume. Specifically, the management computer 40000 runs the volume allocation program 42200 so as to record pieces of information on storage systems, which respective general storage administrators can use, in an allocated storage system access control table 23100. The management computer then receives a volume allocation request that includes information on an administrator, who has requested allocation of a volume, and volume allocation request parameters. In response to the volume allocation request, the management computer 40000 extracts a candidate for volume creation from among the storage systems accessible to the administrator who has requested allocation. Moreover, in response to the volume allocation request, the management computer 40000 extracts a candidate for volume creation from among storage systems accessible to any administrator. A storage system that is a target of volume creation is determined from the two extracted candidates for volume creation. The management computer 40000 issues a volume creation request to the determined storage system. If the storage system determined as the target of volume creation is not a storage system allocated by the administrator who has requested allocation, the storage system determined as the target of volume creation is regarded as one of storage systems allocated by the administrator who has requested allocation.

Referring to FIG. 23, a volume un-allocation program 42300 installed in the management computer 4000 is run in order to verify whether the storage administrator should be deprived of the authority to manage the physical configuration of a storage system including an unallocated volume responsively to un-allocation of the volume. If the storage administrator is recognized to be deprived of the authority, the storage administrator is deprived of the authority.

To be more specific, the management computer 40000 receives a volume un-allocation request that includes information on an administrator who has requested un-allocation of a volume, and volume un-allocation request parameters. In response to the volume un-allocation request, a volume is deleted from a storage system. The management computer 40000 then verifies whether the storage system includes a volume allocated by the administrator who has requested un-allocation. If the result of verification demonstrates that the storage system does not include an allocated volume, the storage system is regarded as a storage system accessible to any administrator. In the present working mode, owing to the two foregoing programs, the authority to manage the physical configuration of a storage system is given or deprived responsively to allocation or un-allocation of a volume. As shown in FIG. 23, each of general storage administrators can manage the physical configuration of a storage system and the logical configuration of a volume alike exclusively to the other general storage administrator. Consequently, the configurations of numerous volumes present in a large-scale data center can be managed easily.

What is claimed is:

1. A computer system comprising:
a plurality of storage systems each including at least one of disk devices being configured into a plurality of volumes in which data to be used by a host computer over a network is stored, and a controller that is coupled to the at least one of disk devices; and
a management computer managing the storage systems over a network,
wherein the management computer comprises:
a port via which the management computer is coupled to the network, a memory storing management rights information including first information indicating that a first administrator has authority to manage configuration of a first storage system in a plurality of the storage systems and a second administrator has authority to manage configuration of a second storage system in a plurality of the storage systems, and second information indicating that authority to manage configuration of a third storage system in a plurality of the storage systems is not given to any administrator,
a processor which performs processes including receiving a volume allocation request including information of the first administrator as a general administrator, selecting the first storage system, whose configuration management authority belongs to the general administrator, and the third storage system, whose configuration management authority does not belongs to any administrator, as a candidate for volume creation based on the management rights information, and sending instruction of volume creation to the selected first storage system or the selected third storage system,
wherein when the processor sends instruction of volume creation to the third storage system, the processor updates the first information and the second information included in the management right information to give authority to manage configuration of the third storage system to the first administrator, and
wherein the controller included in the third storage system receives the instruction of volume creation from the management computer over the network and creates volume in the third storage system.

2. A computer system according to claim 1, wherein the processor sends instruction of volume creation to the first storage system, the controller included in the first storage system receives the instruction of volume creation from the management computer over the network and creates volume in the first storage system.

3. A computer system according to claim 1, wherein the volume allocation request is request for allocation of a volume, in which data is stored, to the host computer which the first administrator can manage, and wherein the management computer notifies the host computer of an identifier with which a target of data storage in which data is stored is identified.

4. A configuration management method for a computer system that comprises a plurality of storage systems each including an at least one of disk devices being configured into a plurality of logical volumes in which data to be used by a host computer over a network is stored, and a storage controller coupled to the at least one of disk devices, the configuration management method comprising the steps of:
receiving a volume allocation request including information of a first administrator as a general administrator;
selecting a first storage system, whose configuration management authority belongs to a general administrator, and a third storage system, whose configuration management authority does not belong to any administrator, as a candidate for volume creation based on management rights information, and sending instruction of volume creation to the selected first storage system or the selected third storage system,
wherein when the processor sends instruction of volume creation to the third storage system, updating first information and second information included in the management right information to give authority to manage configuration of the third storage system to the first administrator, and
wherein the management rights information includes information including first information indicating that the first administrator has authority to manage configuration of the first storage system in a plurality of the storage systems and the second administrator has authority to manage configuration of a second storage system in a plurality of the storage systems, and second information indicating that authority to manage configuration of a third storage system in a plurality of the storage systems is not given to any administrator;
transmitting a volume allocation instruction to the third storage system; and
receiving in the third storage system the instruction of volume creation and creating a volume to the third storage system.

5. A configuration management method according to claim 4, wherein if authority to manipulate a storage system is given to a user, the request relevant to the attribute of logical volume is treated.

6. A configuration management method according to claim 4, wherein if authority to manipulate a storage system is given to any other user, the request relevant to the attribute of logical volume is not treated.

7. A configuration management method according to claim 4, wherein the request relevant to the attribute of logical volume is a request for allocation of logical volume, and a predetermined logical volume is a logical volume that is not allocated to any host computer.

8. A configuration management method according to claim 7, wherein authority to manipulate a storage system includes authority to determine a path along which a logical volume is allocated to the host computer.

9. A configuration management method according to claim 5, wherein a request relevant to an attribute of a logical volume is a request for formatting of a logical volume, and authority to manipulate a storage system includes authority to format logical volume.

10. A configuration management method according to claim 4, wherein the computer system further comprises a host computer and a virtualization system that provides the host computer with a virtual volume associated with a logical volume in which data to be used by the host computer is stored;
a request relevant to the virtual volume is received from a user;
logical volume associated with the virtual volume is searched in order to identify a storage system including the searched logical volume;
information on authority to manipulate a storage system that is given to any user is referenced;
if a result of referencing demonstrates that authority to manipulate the storage system is given to the user, the request relevant to a virtual volume is treated;
if the result of referencing demonstrates that authority to manipulate the storage system is not given to any user, the authority to manipulate the storage system is given to the user and the request relevant to the virtual volume is treated; and
if the result of referencing demonstrates that the authority to manipulate the storage system is given to any other user, the request is not treated.
